(19) United States
(12) Patent Application Publication
(10) Pub. No.: US 2006/0020960 A1
(43) Pub. Date: Jan. 26, 2006

(54) System, method, and apparatus for secure sharing of multimedia content across several electronic devices

(76) Inventors: Sandeep Relan, Bangalore (IN); Brajabandhu Mishra, Orissa (IN); Rajendra Khare, Bangalore (IN)

Correspondence Address: MCANDREWS HELD & MALLOY, LTD, 500 WEST MADISON STREET, SUITE 3400, CHICAGO, IL, 60661, US

(21) Appl. No.: 11/220,185

(22) Filed: Sep. 6, 2005

Related U.S. Application Data
(63) Continuation-in-part of application No. 11/063,944, filed on Feb. 23, 2005.
(63) Continuation-in-part of application No. 10/863,945, filed on Jun. 9, 2004.
(63) Continuation-in-part of application No. 10/819,868, filed on Apr. 7, 2004.
(63) Continuation-in-part of application No. 10/826,183, filed on Apr. 16, 2004.
(63) Continuation-in-part of application No. 10/807,686, filed on Mar. 24, 2004.

(51) Int. Cl. H04N 7/16; H04N 7/167; H04N 7/173

(52) U.S. Cl. 725/30; 725/31; 725/141; 725/123

(57) ABSTRACT

Disclosed herein is a secure, media exchange network and a method of securely exchanging media between electronic devices across the network. In an embodiment according to the present invention, media may be securely and simultaneously exchanged between friends, family members, business associates, government entities, military entities, law enforcement entities, and 3rd party media providers over a closed and secure media exchange network. The media may include, for example, digital video, digital audio, digital images, digital data, or any other form of digital information. Security features may include security techniques, associated security hardware, and associated security software.

### RELATED APPLICATIONS

The present application is a Continuation-In-Part of U.S. Non-Provisional patent application Ser. No. 11/063,944 (Attorney Docket Number 15913US01), filed on Feb. 23, 2005, entitled “SYSTEM, METHOD, AND APPARATUS FOR SECURE SHARING OF MULTIMEDIA CONTENT ACROSS SEVERAL ELECTRONIC DEVICES”, the complete subject matter of which is hereby incorporated herein by reference, in its entirety.

The present application is also a Continuation-In-Part of U.S. Non-Provisional patent application Ser. No. 10/863,945 (Attorney Docket Number 15794US01), filed on Jun. 9, 2004, entitled “METHOD EMPLOYING PERSONAL MULTIMEDIA-PROGRAM RECORDING APPLICATIONS IN ELECTRONIC DEVICES”, the complete subject matter of which is hereby incorporated herein by reference, in its entirety.

The present application is also a Continuation-In-Part of U.S. Non-Provisional patent application Ser. No. 10/819,868 (Attorney Docket Number 15468US01), filed on Apr. 7, 2004, entitled “UNICAST CABLE CONTENT DELIVERY”, the complete subject matter of which is hereby incorporated herein by reference, in its entirety.

The present application is also a Continuation-In-Part of U.S. Non-Provisional patent application Ser. No. 10/826,183 (Attorney Docket Number 15485US01), filed on Apr. 16, 2004, entitled “SYSTEM AND METHOD FOR MULTIMEDIA VIEWERSHIP SURVEYING”, the complete subject matter of which is hereby incorporated herein by reference, in its entirety.

The present application is also a Continuation-In-Part of U.S. Non-Provisional patent application Ser. No. 10/807,686 (Attorney Docket Number 15487US01), filed on Mar. 24, 2004, entitled “GLOBAL POSITIONING SYSTEM (GPS) BASED SECURE ACCESS”, the complete subject matter of which is hereby incorporated herein by reference, in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Cable television (CATV) has become a widely subscribed to commodity. CATV typically comprises a plurality of audio/video (A/V) transmissions accumulated in a central office, for example. The A/V transmissions may be accumulated in a content server, for example.

A content server is an information storage unit adapted to collect, accumulate, package, disseminate, and broadcast multimedia-program data/information to clients/customers/subscribers at various locations remote from the central office.

A common central content server may be located in a central office of a service provider. The content server may comprise a plurality of servers residing in multiple geographic locations.

Typically, CATV transmissions (channels) are distributed to end-users over cables, thus cable TV. The channels may be distributed from a content server located at a local CATV service provider's location. The service provider's content server may be adapted to transmit all of the channels simultaneously on a single shared cable to an end-user location.

Multiple clients, end-users, and/or customers may subscribe to the channels and/or services provided by the content server of the CATV service provider. A television set and a set-top-box (STB) may be located at the end-user's location to decode and display the channels. The STB may provide end-users access to (i.e., decodes) only those channels that the end-user subscribes.

Ordinarily, there may be a signal distribution unit situated at the CATV service provider's location. The signal distribution unit may be adapted to receive all channels via at least one satellite signal-receiving unit, and subsequently via at least one satellite. The subscribing end-user's STB may be connected to the end-user's TV set. The end-user may be provided with a smart card for authentication and identification purposes.

Each end-user may subscribe to different channel packages and the number of channels subscribed to by each end-user may vary. Cables may connect the signal distribution unit at the service provider's location to each STB and TV set at each individual end-user location. The signal distribution unit may transmit all of the received channels to all of the end-user locations at once.

The STB may be adapted to permit access to (viewing of) channels that the end-user has subscribed, while barring access to (denying viewing of) channels that the end-user has not subscribed. The end-user may select a subscribed channel for viewing by remotely controlling the STB, causing the STB to decode and send a particular channel to the TV set for display and viewing.

Today, people have many digital media devices and media types available to them, such as digital cameras providing still pictures, DVD's and digital camcorders providing moving video, and CD's and MP3 players providing audio, for example. Different software may be required to deliver the different media using a personal computer (PC). The user interfaces for the different media types may also be different from each other.

If, for example, a son wants to send digital pictures from his digital camera to his mother, she would need to have a PC, he would have to send the pictures via e-mail, and she would have to be e-mail savvy and should have correct software for sending and receiving emails. The mother would also need the correct software to view the pictures. The son may have to talk his mother through the process of how to view the pictures on her PC. The pictures exist in a large e-mail file and may be lost if the mother or son upgrades their PC by, for example, formatting the hard-disk or if their PC crashes or get corrupted by viruses.

If the son wants to show the pictures to people at his home, he would need to have everyone gather around his PC, which does not provide for a good sharing experience.

Certain types of sales and advertisement media and new music media are typically only available in a PC environment and may not be accessible by a television or other display device. Currently, television provides mostly fixed media and there is not much interactivity, such as for example, as is provided by a PC and Internet environment. A television viewer is essentially limited to watching fixed media including the same commercials that everyone else is watching.

Media devices may be battery powered, portable, or mobile devices that are designed to operate while in motion (“roaming media devices”), or may be designed for operation while in a fixed location and usually connected to a power outlet (“stationary media devices”). Typical media devices, including media capture and playback devices such as video and image cameras, audio recorders, and video, audio and image players are designed for direct user control.

Direct user control of such media devices may occur manually through buttons, switches, and/or keypads on the media device or on an associated remote control device. With direct user control, users have access to a wide set of device commands, such as power on or off, play, rewind, capture, erase, delete, zoom, rewind, skip, sleep, standby, volume, brightness, modes, scan, info, and guide, for example. Direct access to media (for playback, review, etc.) in typical media devices is but one result of direct control.

Many of such media devices may also employ displays, light emitting diodes, and other visual components to assist the user in carrying out direct user control. Audible or audio components are also often employed to assist.

Most media devices offer no means for indirect control, and, for those that do, the indirect control may be very limited and difficult to use. Indirect control may comprise control that is initiated from an independent device that may or may not be operated by the user. Independent devices do not include remote control devices that communicate directly with the media device (associated remote control devices).

Further limitations and disadvantages of conventional and traditional approaches will become apparent to one of skill in the art, through comparison of such systems with some aspects of the present invention as set forth in the remainder of the present application with reference to the drawings.

### SUMMARY OF THE INVENTION

A system and/or method supporting secure exchange of multimedia information, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an exemplary embodiment of a media exchange network supporting the exchange of multimedia information, in accordance with various aspects of the present invention.

FIG. 2 is a diagram illustrating an exemplary embodiment of an MPS (media processing system), in accordance with various aspects of the present invention.

FIG. 3A is a diagram illustrating an exemplary broadband network/wireless infrastructure that may be representative of the broadband network/wireless infrastructure illustrated in FIG. 1, in accordance with various aspects of the present invention.

FIG. 3B is a block diagram of an exemplary communication system that supports the secure exchange of multimedia content, in accordance with an embodiment of the present invention.

FIG. 4 is a flowchart illustrating an exemplary method of employing the media exchange network of FIG. 1 for performing media exchange, in accordance with various aspects of the present invention.

FIG. 5 illustrates a media exchange network for exchanging and sharing media information in accordance with an embodiment of the present invention.

FIG. 6 illustrates exemplary push of, personal and third party media, respectively, in accordance with embodiments of the present invention.

FIG. 7 illustrates exemplary push of, personal and third party media, respectively, in accordance with other embodiments of the present invention.

FIG. 8 illustrates an exemplary media exchange network comprising a (PC/STB/M-box) to (PC/STB/M-box) configuration, in accordance with an embodiment of the present invention.

FIG. 9 illustrates an exemplary media exchange network adapted to provide digital media exchange, in accordance with an embodiment of the present invention.

FIG. 10 illustrates an exemplary media exchange network comprising an Internet infrastructure, a cable broadband infrastructure, and a CATV headend server, in accordance with an embodiment of the present invention.

FIG. 11 is a schematic block diagram illustrating various exemplary elements associated with various exemplary embodiments of the present invention.

FIG. 12 is a block diagram of an exemplary enhanced set-top-box, in accordance with an embodiment of the present invention.

FIG. 13 illustrates an exemplary set-top-box employing an M-box adapter, in accordance with an embodiment of the present invention.

FIG. 14 illustrates an exemplary upgrading of a set-top-box with software, in accordance with an embodiment of the present invention.

### DETAILED DESCRIPTION OF THE INVENTION

Certain embodiments of the present invention may relate to the field of multimedia exchange and multimedia sharing. More specifically, certain embodiments of the present invention may relate to the exchange and sharing of multimedia information between, for example, family members and friends in an efficient, user-friendly, and economically viable manner over a closed and secure multimedia exchange network, such as for example, a cable television (CATV) multimedia network.

Digital media may be pushed from one user to another over a multimedia exchange network, or pulled from one location to another over the multimedia exchange network, in accordance with various embodiments of the present invention. Sources of media on the multimedia exchange network may include digital storage devices, such as for example, servers, PC's, MPS's (media processing systems), media storage servers (e.g., NAS (network attached storage) units), and media peripheral devices.

In accordance with an embodiment of the present invention, a media peripheral device may comprise a computer running media capture software and/or media player software and having functionality that may be coordinated through, for example, a TV screen and/or a speaker system.

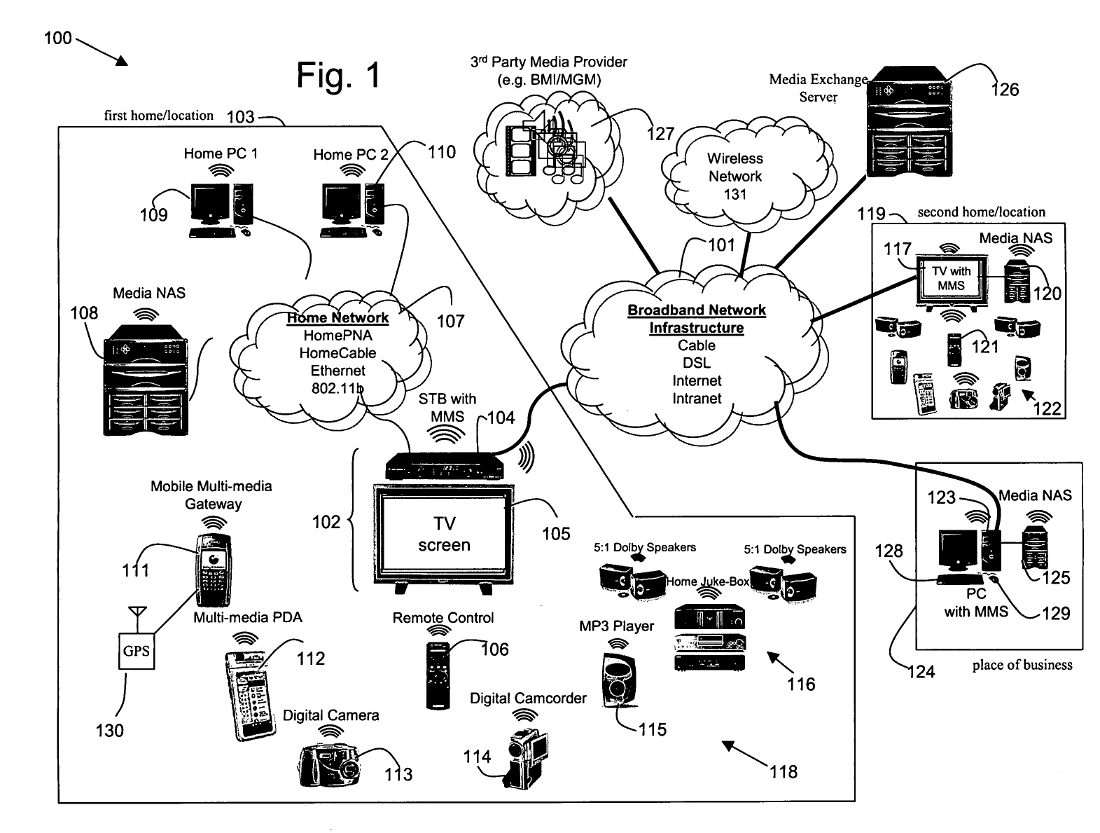

FIG. 1 is a diagram illustrating an exemplary embodiment of a media exchange network 100 supporting the exchange of multimedia information, in accordance with various aspects of the present invention. The various types of media may include, for example, digital video, digital audio, digital images, digital data, and any other type of digital information. In accordance with an embodiment of the present invention, media may be stored in the form of digital files (e.g., a MP3 file, a MPEG 2 file, for example).

A media exchange network 100 may comprise a communications network comprising, for example, a broadband network infrastructure 101, a first MPS 102 in a first private home/location 103 comprising a STB (set-top-box) 104 incorporating a MMS (media management system) also known as a MES (media exchange software) platform, and a TV screen 105.

In an embodiment according to the present invention, the set-top-box circuitry may be incorporated in a combination display apparatus such as, but not limited to, a television set incorporating hardware and software adapted to receive and decode multimedia information. The term decoding as used herein may representative of a number of functions including, but not limited to, decompression and/or decryption.

Functionality provided by the MMS in the STB 104 may be controlled by a remote control 106. The media exchange network 100 may also comprise a home/location network 107, a media NAS (network attached storage) unit 108, a first home/location PC 109, and a second home/location PC 110 all in the first home/location 103, for example.

In an embodiment according to the present invention, the media exchange network 100 may also comprise a plurality of media peripheral devices 118 including a mobile multi-media gateway 111 that may have a global positioning system (GPS) receiver 130, a multi-media PDA 112, a digital camera 113, a digital camcorder 114, an MP3 player 115, and a music jukebox 116 all in the first home/location 103, for example. In accordance with an embodiment of the present invention, a media peripheral device may also comprise a PC, for example.

In an embodiment according to the present invention, the media exchange network 100 may further comprise an MPS 117 comprising a TV incorporating a MMS at a second home/location 119. Functionality provided by the MMS in the MPS 117 may be controlled by a remote control 121. The media exchange network 100 may also comprise a media NAS unit 120 and a plurality of media peripheral devices 122 at the second home/location 119.

In an embodiment according to the present invention, the media exchange network 100 may further comprise an MPS 123 including a PC incorporating an MMS at a place of business 124, for example.

A PC-based MPS, such as for example, MPS 123, may be equipped with a television tuner card to permit MPS 123 to access over-the-air (OTA) broadcast media, for example. A keyboard 128 and/or a mouse 129 may control functionality provided by the MMS in the MPS 123.

In an embodiment according to the present invention, the media exchange network 100 may also include a media NAS unit 125 at the place of business 124, for example. The media exchange network 100 may comprise a media exchange server 126 and a 3rd party media provider 127 (or 3rd party service provider), for example.

In an embodiment according to the present invention, the MPS 102, the MPS 117, the MPS 123, the media exchange server 126, and the 3rd party media provider 127 may interface with the broadband network infrastructure 101, for example. The broadband network infrastructure 101 may be communicatively coupled to a wireless network 131 that may, for example, comprise a cellular, two-way paging, or other wireless wide area network capable of supporting geo-location of mobile terminals such as a cellular handset or a mobile multimedia gateway such as the mobile multimedia gateway 111, for example. Such geo-location may, for example, be based upon the operation of the mobile terminal within the wireless infrastructure of the wireless network 131, or the geo-location may be based upon a satellite-based geo-location system such as, for example, the global positioning system (GPS). In any case, the physical location of the mobile terminal may act as an element in the verification of the authority, or authenticate, the user requesting exchange of multimedia content via the media exchange network 100.

The STB 104 may interface via a wired or wireless connection to the TV screen (display apparatus) 105 forming the MPS 102 at the first home/location 103. The MPS 102 may connect to the home/location network 107 via a wired or wireless connection. The media NAS unit 108, the first PC 109, and the second PC 110 may each interface to the home network 107 as well, via a wired or wireless connection. Each media peripheral device of the plurality of media peripheral devices 118 may interface to the MPS 102 via a wired or wireless connection.

In an embodiment according to the present invention, the MPS 117 may interface, via a wired or wireless connection, to the media NAS unit 120 at the second home/location 119. Each media peripheral device of the plurality of media peripheral devices 122 may interface, via a wired or wireless connection, to the MPS 117, for example. The MPS 123 may interface, via a wired or wireless connection, with the media NAS unit 125 at the place of business 124, for example.

In an embodiment according to the present invention, the PC's 109, 110, and 123 (i.e., the MPS 123) may comprise desktop PC's, notebook PC's, PDA's, or any other computing devices, for example. The broadband network infrastructure 101 may include cable television (CATV) infrastructure, direct subscriber line (DSL) infrastructure, the Internet, intranet infrastructure, and broadband access head ends including cable head ends, and a satellite head end, for example, in order to provide communications between the first home/location 103, the second home/location 119, the place of business 124, and the 3rd party media provider 127, for example.

A CATV infrastructure in an embodiment of the present invention may, for example, make available a greater amount of bandwidth for the exchange of media content, by reducing the bandwidth occupied by programming channels distributed to subscribers. This may be accomplished, for example, by transmitting via portions of the cable infrastructure, only those programming channels in which there is a demonstrated interest and to which the subscribers of that portion of the infrastructure are entitled. The expanded amount of unused bandwidth may be used for the exchange of media content as described herein.

In an embodiment according to the present invention, the home/location network 107 may include at least one of home PNA (phoneline networking alliance) infrastructure, home cable infrastructure, Ethernet infrastructure, and wireless infrastructure, for example, providing peer-to-peer networking capability within the first home/location 103. The 3rd party media provider 127 may comprise, for example, a provider of digital music, a provider of digital movies, a provider of games, and/or a provider of consumer services (e.g., software updates from a media peripheral device manufacturer), for example. The terms peer-to-peer and peer2peer may be used herein, interchangeably, to refer to a communication network in which information is transferred or shared by one user with another, using the same program or type of program (i.e., peers). Such networks typically operate without intermediate storage and retrieval of the information on a storage facility or server.

In an embodiment according to the present invention, the MMS's in the MPS's 102, 117, and 123 may each comprise a software platform operating on at least one processor to provide certain functionalities including user interface functionality, distributed storage functionality, and networking functionality, for example.

An MMS may provide personal media channel construction supporting audio, video, images, image sequence selection, text, voice overlay, channel and program naming, and inter-home MPS routing selection, in accordance with an embodiment of the present invention.

In addition, the MMS software platform in a PC-based MPS, such as for example, MPS 123 may permit access to over-the-air (OTA) broadcast media using a television tuner card installed within the MPS 123, for example. An MPS may also be known, herein, as a media-box and/or an M-box, for example.

In an embodiment according to the present invention, the media exchange server 126 may provide functionality of distributed networking capability, archival functionality (long term media storage), temporal storage (to aid in the distribution and routing of media), distributed storage management, digital rights management (e.g., authentication/authorization), network management, billing, and software application program interfacing on the media exchange network 100, for example. In a representative embodiment of the present invention, the media exchange server 126 may function independently, or in cooperation with other network elements to allocate bandwidth in the broadband network infrastructure 101, for example, for the exchange of multimedia information in response to requests from MPS's such as, for example, the MPS 102 at the first home/location 103 and the MPS 117 at the second home/location 119 of FIG. 1.

In an embodiment according to the present invention, a media NAS unit such as, for example, the media NAS units 108, 120, 125 may comprise a collection of mass storage devices contained in a single unit with a built-in operating system. An NAS unit may comprise a dedicated computer that manages storage devices and maybe “tuned” to store media.

An NAS unit may serve a single user or multiple users on the media exchange network 100 at the same time. An NAS unit may provide storing, retrieving, and printing, and may also comprise, for example, an Ethernet card or a wireless network interface car (NIC) card for connectivity.

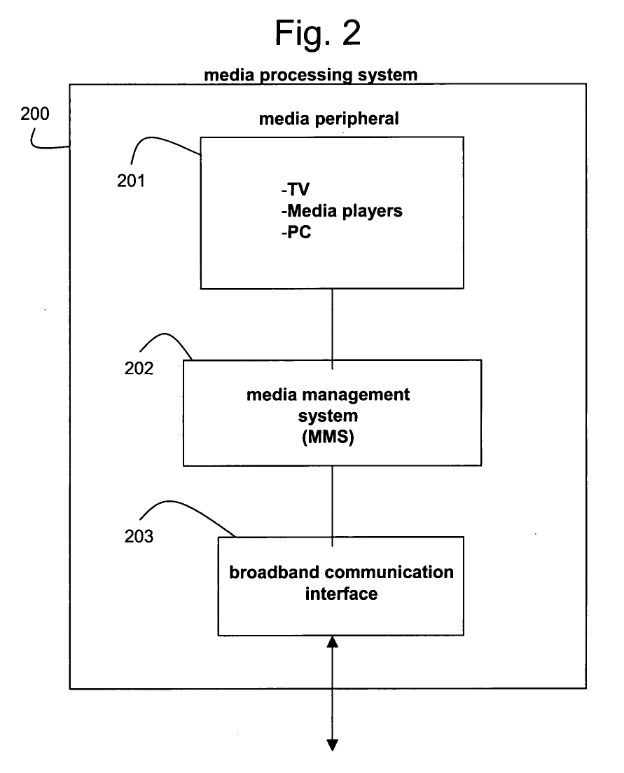

FIG. 2 is a diagram illustrating an exemplary embodiment of an MPS (media processing system) 200, in accordance with various aspects of the present invention. The MPS 200 may comprise a media peripheral 201 (e.g., a TV), an MMS 202, and a broadband communications interface 203.

The media peripheral 201 may also comprise a media player or a PC, for example. The broadband communications interface 203 may provide connectivity to a broadband network infrastructure, such as for example, the broadband network infrastructure 101 illustrated in FIG. 1.

The broadband communications interface 203 may comprise, for example, a cable modem, a digital subscriber line (DSL) modem, an Ethernet card, or an wireless network interface card (NIC), or a Bluetooth® interface (Bluetooth® is a trademark registered to Bluetooth SIG), or optical fiber interface, or other communication interface.

In accordance with an embodiment of the present invention, an MPS may also comprise a remote control user interface to allow control of functionality of the MPS employing, for example, a remote control device, a keyboard, and/or a mouse.

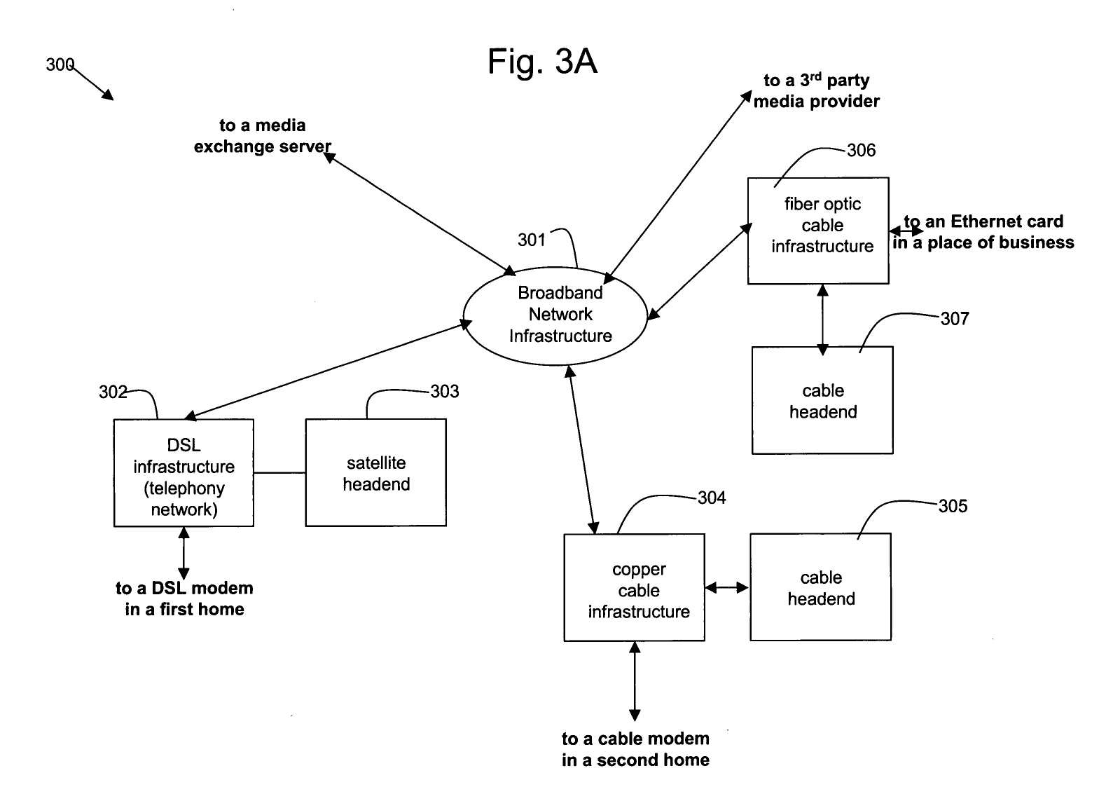

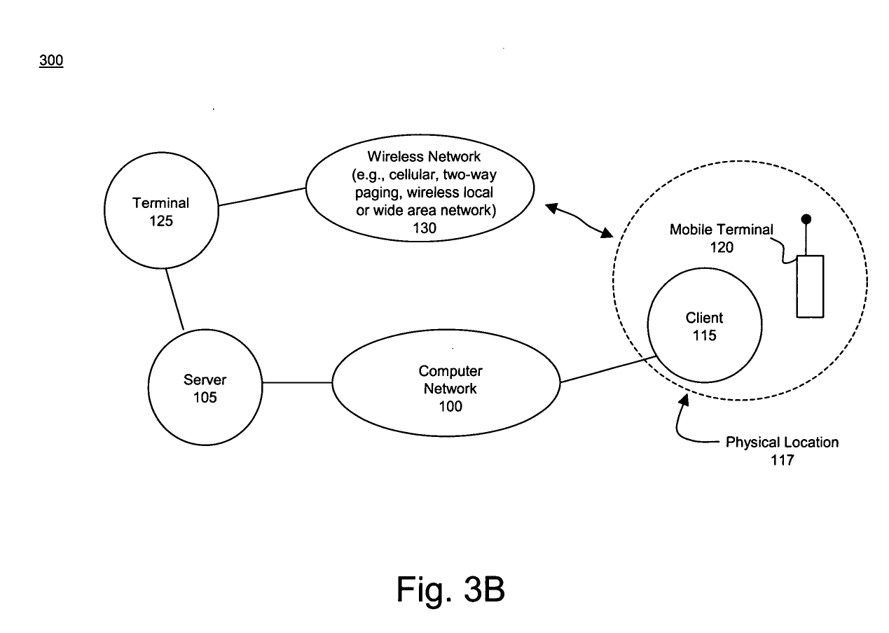

FIG. 3A is a diagram illustrating an exemplary broadband network/wireless infrastructure 300 that may be representative of the broadband network/wireless infrastructure 101 illustrated in FIG. 1, in accordance with various aspects of the present invention.

The broadband network/wireless infrastructure 300 may comprise an Internet infrastructure 301, a DSL infrastructure 302, a satellite head end 303, a copper cable infrastructure 304, a first cable (e.g., CATV) head end 305, a fiber optic cable infrastructure 306, and/or a second cable (e.g., CATV) head end 307, for example. The broadband network/wireless infrastructure may comprise wired connections, fiber optic connections, and wireless connections in accordance with an embodiment of the present invention.

In accordance with an embodiment of the present invention, the DSL infrastructure 302, the copper cable infrastructure 304, and the fiber optic cable infrastructure 306 may each interface to the Internet infrastructure 301, for example. The Internet infrastructure 301 may also interface to a media exchange server and/or a 3rd party media provider in a media exchange network, for example.

In accordance with an embodiment of the present invention, the DSL infrastructure 302 may interface to the satellite head end 303 which may be managed by a satellite program provider, for example. The copper cable infrastructure 304 may interface to the first cable (e.g., CATV) head end 305 and may be managed by a first cable program provider.

The fiber optic cable infrastructure 306 may interface to the second cable (e.g., CATV) head end 307 and may be managed by a second cable program provider. The second cable program provider may be similar to the first cable program provider except that the programming may be routed over fiber optic cable instead of traditional copper cable, for example. The broadband network/wireless infrastructure may comprise wired connections, fiber optic connections, and wireless connections in accordance with an embodiment of the present invention.

In accordance with an embodiment of the present invention, the DSL infrastructure 302 may interface to a DSL modem in a first home/location (e.g., the first home/location 103 illustrated in FIG. 1) to provide satellite programming and other services to the first home/location 103, for example.

The copper cable infrastructure 304 may interface to a copper cable modem in a second home/location (e.g., the second home/location 119 illustrated in FIG. 1) to provide cable programming and other services to the second home/location 119, for example.

The fiber optic cable infrastructure 306 may interface to an Ethernet card in a place of business (e.g., the place of business 124 illustrated in FIG. 1) to provide cable programming and other services to the place of business 124, for example.

In accordance with an embodiment of the present invention, the DSL modem may interface to an MPS in the first home/location 103, the cable modem may interface with an MPS in the second home/location 119, and the Ethernet card may interface with an MPS in the place of business 124, for example.

In accordance with an embodiment of the present invention, the DSL modem in the first home/location 103 may be part of a DSL MPS, for example. In accordance with an embodiment of the present invention, the cable modem in the second home/location 119 may be part of a cable MPS.

In accordance with an embodiment of the present invention, the Ethernet card in the place of business 124 may be part of an Ethernet MPS, for example. The DSL modem, the cable modem, and the Ethernet card may each constitute a broadband communications interface within an MPS, such as the MPS illustrated in FIG. 2.

In an embodiment of the present invention, any of the Internet infrastructure 301, the DSL infrastructure 302, the satellite head end 303, the copper cable infrastructure 304, the first cable (e.g., CATV) head end 305, the fiber optic cable infrastructure 306, and the second cable (e.g., CATV) head end 307 of the broadband network/wireless infrastructure 300 may be capable of allocating bandwidth upon request for the exchange of media content.

For example, the elements comprising a CATV infrastructure may be capable of transporting a large number of channels of programming to/from a user location. In conventional CATV systems, a CATV system operator may occupy all of the programming channels on the cable to user locations, even though only a small portion may be consumed by subscribers at any point in time. By distributing all available system programming to subscriber locations, the system operator unnecessarily exposes to theft, programming channels that are not currently of interest to subscribers. In addition, by distributing unused system programming channels, the system operator occupies cable bandwidth that might otherwise be used for alternate services such as, for example, up and downstream paths for cable internet, and higher bandwidth/better quality of service for programming materials of interest to subscribers.

In an embodiment of the present invention, an MPS such as the MPS 102 at first home/location 103 of FIG. 1 or the MPS 117 at second home/location 118 of FIG. 1, for example, may issue a request for the infrastructure bandwidth needed for the exchange of media content. Such as request may be directed to, for example, a server such as the media exchange server 126 of FIG. 1. In a broadband network infrastructure such as the broadband network infrastructure 101 of FIG. 1 comprising a CATV infrastructure, a network entity such as the media exchange server 126 may authenticate such a bandwidth request, and may communicate with elements of the broadband network infrastructure (e.g., CATV infrastructure) to make available the bandwidth to enable the desired exchange of media content. Additional details of such a scheme of bandwidth allocation in a CATV network may be found in U.S. patent application Ser. No. 10/819,868, entitled “UNICAST CABLE CONTENT DELIVERY” (Attorney Docket No. 15468US01), filed Apr. 7, 2004, the complete subject matter of which is hereby incorporated herein by reference, in its entirety.

In an embodiment of the present invention, a request for the exchange of multimedia information from a first MPS such as, for example, the MPS 102, and a second MPS such as, for example, the MPS 117 may employ security-related information from a user for authenticating the request. Such security-related information may, for example, comprise a password and/or a digital certificate provided by the user or by the MPS of the user requesting the exchange. In addition, an embodiment of the present invention may employ position or physical location information about the geographic location of a mobile terminal or handset such as, for example, a cellular phone that is associated with the user making the request. Other such devices may also be employed including, for example, two-way paging devices, mobile multimedia handsets, mobile multimedia gateways, personal digital assistants, and personal computers equipped with wireless interfaces, to name only a few devices. Such password or digital certificate information, and geographic position/location information of an associated mobile handset may, for example, be evaluated and/or verified by the source or destination of a requested multimedia information exchange, before exchange of the multimedia information is permitted to proceed.

In an embodiment of the present invention, the position/location information may comprise, for example, coordinate information from a global positioning system (GPS) receiver (or another positioning means) within or in communication with the mobile handset, and/or may comprise information identifying the location of the mobile handset within a wireless network infrastructure such as, for example, the serving cell and/or sector of a cellular telephone network. An example of one embodiment of such a mobile handset device is shown in FIG. 1 as mobile multimedia gateway 111 with GPS receiver 130. Other embodiments may not employ a GPS receiver such as, for example, the GPS receiver 130, and may instead use location information available from the mobile handset or from a wireless infrastructure that supports the mobile handset. The wireless infrastructure may comprise, for example, a conventional cellular infrastructure. In an embodiment of the present invention, the evaluation and/or verification may comprise comparing the position/location information made available at the time of the request for the exchange, with predetermined position(s) provided by, for example, the individual or organization responsible for the second MPS (e.g., MPS 117). If the position/location information available at the time of the requested exchange matches or is within a predefined margin about one or more of the predetermined position(s), then a match may be declared and the location of the mobile handset may be determined to be verified and/or valid. Details of such a security mechanism may be found in U.S. patent application Ser. No. 10/807,686 entitled “GLOBAL POSITIONING SYSTEM (GPS) BASED SECURE ACCESS” (Attorney Docket Number 15487US01), filed on Mar. 24, 2004, the complete subject matter of which is hereby incorporated herein by reference, in its entirety. Through the use of such a mechanism, the exchange of multimedia information may be limited to authenticated users, and may further be limited to those users attempting access from pre-determined geographic locations.

FIG. 3B is a block diagram of an exemplary communication system 300 that supports the secure exchange of multimedia content, in accordance with an embodiment of the present invention. The system includes a computer network 100 and a wireless network 130.

The communication system 300 includes a server 105 that is accessible over the computer network 100 by a client terminal 115 in a physical location 117. The computer network 100 is any electronic, optical information distribution, or wireless network and can comprise any combination of a variety of communication media, such as, but not limited to, the internet, the public switched telephone network, a local area network (LAN), and a wide area network (WAN).

The server 105 may provide access to a database storing sensitive information or the like, or allow individuals to perform various transactions. Accordingly, it is important to control access to the server 105. As a result, the server 105 requires a password from the client terminal 115 that validates the identity of the user at the client terminal 115.

As an additional layer of security, the computer network 100 requires the authorized user to access the computer network 100 from the physical location 117. The particular physical location 117 is preferably a physically secured location that is not accessible by the general public. When an authorized user attempts to access the computer network 100, the computer network 100 requests the user to provide a password. Additionally, the computer network 100 uses the wireless network 130, via terminal 125 to locate the position of a mobile terminal 120 associated with the user. The terminal 125 is a terminal that has access to the wireless network 130, either directly, or via another network. For example, the terminal 125 can comprise a computer connected to either the wireless network 130 or the public switched telephone network.

The computer network 100 grants access to the user, if the user provides the proper password, and the mobile terminal 120 is located in the physical location 117.

It is noted now that an unauthorized user needs, not only an authorized user's password, but also the ability to place the authorized user's mobile terminal 120 at the physical location 117 to access the computer network 100. Furthermore, even if an unauthorized user succeeds in remotely accessing the client terminal 115, the computer network 100 will not grant the unauthorized user access to the computer network 100. Accordingly, remote access need not be cut off from the client terminal 115. This allows the client terminal 115 to be used for other purposes, such as accessing the internet.

In certain embodiments of the present invention, the mobile terminal 120 may be configured to display a time-varying password that is used to access the computer network.

In the illustration of FIG. 3B, the wireless terminal 120 may correspond to, for example, a mobile handset such as the mobile multimedia gateway 111 of FIG. 1. The client 115 may correspond to, for example, an MPS such as the MPSs 102, 117 or PCs 109, 110, 123. The computer network 100 may correspond to, for example, the broadband network 101, while the server 105 may correspond to, for example, the media exchange server 126 of FIG. 1. The terminal 125 may correspond to another of the MPSs 102, 117 or PCs 109, 110, 123, and the wireless network 130 may correspond to, for example, the wireless network 131 of FIG. 1.

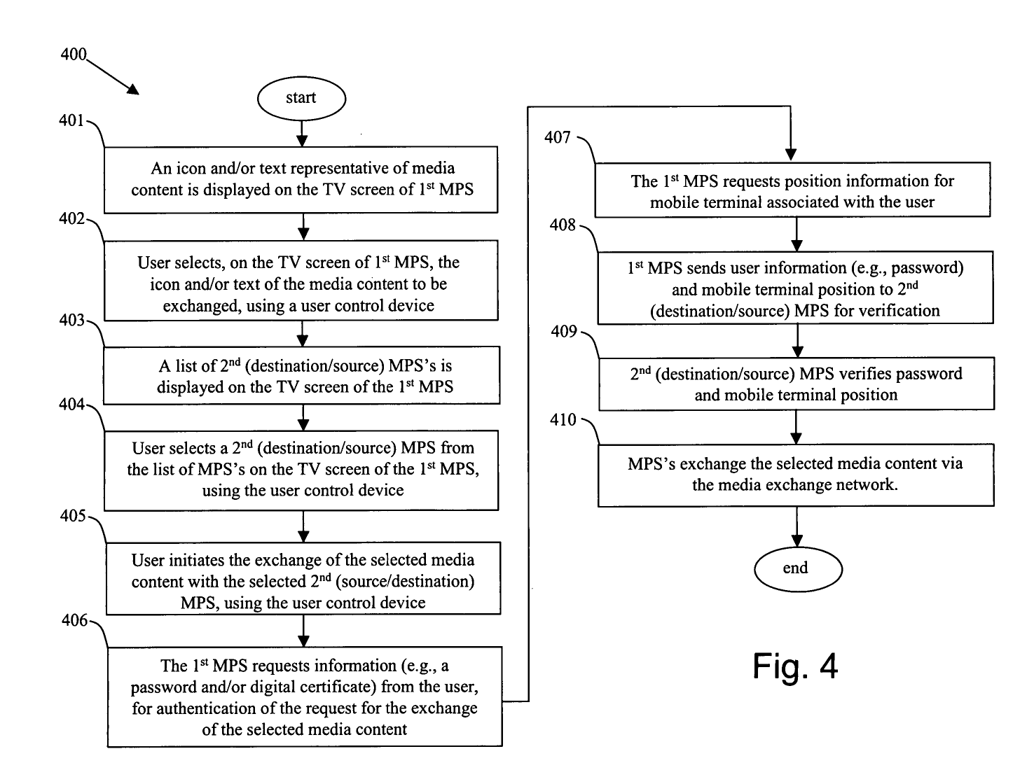

FIG. 4 is a flowchart 400 illustrating an exemplary method of employing the media exchange network 100 of FIG. 1 for performing media exchange, in accordance with various aspects of the present invention. The method begins following the display of an icon and/or text that is representative of media content, on the TV screen of a 1st MPS such as, for example, the MPS 102 of FIG. 1 (block 401).

In accordance with an embodiment of the present invention, a title of a media content file may be displayed in a scheduled time slot for a channel in a channel view window (for example, a media guide).

In accordance with an embodiment of the present invention, a user may select, on the TV screen of 1st MPS, the icon and/or text of the media content to be exchanged, using a user control device, (block 402).

In accordance with an embodiment of the present invention, a list of 2nd (destination/source) MPS's such as, for example, the MPS 117 of FIG. 1 may then be displayed on the TV screen of the 1 st MPS (e.g., MPS 102) (block 403).

In accordance with an embodiment of the present invention, the user of the first MPS may select a 2nd (destination/source) MPS (e.g., MPS 117) from the list of MPS's on the TV screen of the 1 st MPS (e.g., MPS 102), using the user control device (block 404).

In accordance with an embodiment of the present invention, the user of the first MPS (e.g., MPS 102) may initiate the exchange of the selected media content with the selected 2nd (source/destination) MPS (e.g., MPS 117), using the user control device (block 405).

In accordance with one embodiment of the present invention, the 1st MPS (e.g., MPS 102) may request information (e.g., a password and/or a digital certificate) from the user of the first MPS, for authentication of the request for the exchange of the selected media content (block 406). In other embodiments of the present invention, the first MPS (e.g., MPS 102) may communicate with a server (e.g., media exchange server 126), that may request information for authenticating the user request.

In accordance with one embodiment of the present invention, the first MPS (e.g., MPS 102) may request position information for a mobile terminal associated with the user (block 407). In various other embodiments of the present invention, the first MPS (e.g., MPS 102) may communicate with a server (e.g., the media exchange server 126) that may request position information for the mobile terminal associated with the user.

In accordance with one embodiment of the present invention, the first MPS (e.g., MPS 102) may send the information for authentication of the user, and the position information to the second MPS (e.g., MPS 117) for verification (block 408). In another embodiment of the present invention, the first MPS (e.g., MPS 102) may send the information for authentication of the user, and the position information, to a server for verification. Such information for authentication of the user may be sent with the request for the exchange of multimedia content, or may be sent separately. The request may comprise an indication of the bandwidth desired for the exchange of requested multimedia information. Such bandwidth may be allocated from unused bandwidth in, for example, a cable TV (CATV) network that employs bandwidth conservation through limiting cable programs to those requested and authorized.

In accordance with one embodiment of the present invention, the second (destination/source) MPS (e.g., MPS 117) may verify the authentication information (e.g., password and/or digital certificate and mobile terminal position) and may enable the exchange of the requested media content (block 409). In other embodiments of the present invention, a server may verify the authentication information (e.g., password and/or digital certificate and mobile terminal position) and may enable the exchange of the requested media content between the first and second MPSs (e.g., MPS 102 and 117, respectively). In some embodiments of the present invention, allocation of network bandwidth for the exchange of the requested media content may also be performed based upon the exchange request. Details of such a network in which portions of network bandwidth may be allocated based on request may be found in U.S. Non-Provisional patent application Ser. No. 10/819,868 (Attorney Docket Number 15468US01), filed on Apr. 7, 2004, entitled “UNICAST CABLE CONTENT DELIVERY”, the complete subject matter of which is hereby incorporated herein by reference, in its entirety. Additional details may also be found in U.S. Non-Provisional patent application Ser. No. ______ (Attorney Docket Number 15918US01), filed on Jul. 7, 2005, entitled “CONVERGENCE OF NETWORK FILE SYSTEM FOR SHARING MULTIMEDIA CONTENT ACROSS SEVERAL SET-TOP-BOXES”, the complete subject matter of which is hereby incorporated herein by reference, in its entirety.

In accordance with an embodiment of the present invention, the media content may then be exchanged between the first and second MPSs (e.g., MPS 102 and 117, respectively) (block 410). For example, in one situation the first MPS (e.g., MPS 102) may receive multimedia content from the second MPS (e.g., MPS 117), while in another situation, the first MPS (e.g., MPS 102) may send multimedia information to the second MPS (e.g., MPS 117).

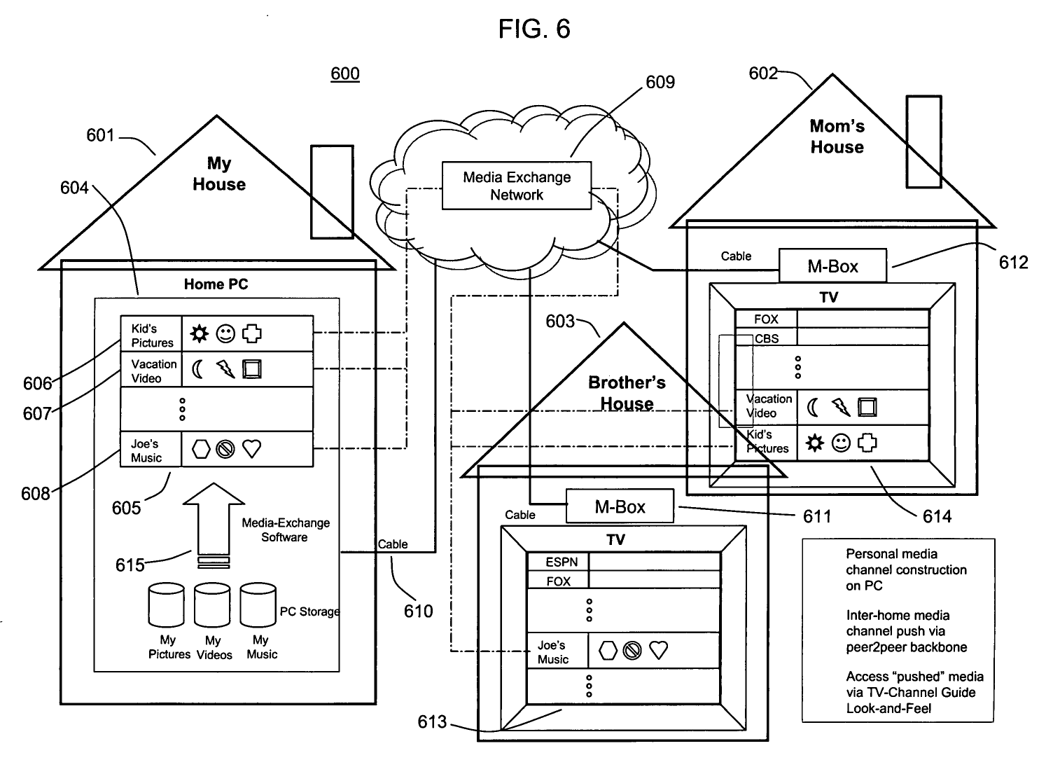

The following example is provided to demonstrate the method for performing media exchange illustrated in the flowchart of FIG. 4 employing the elements illustrated in FIG. 1 and FIG. 6.

In accordance with an embodiment of the present invention, a user of an MPS, such as for example, the MPS 102 located at the first home/location 103 may choose to transfer a file of digital images to the user of a second MPS, such as for example, the MPS 117 at the second home/location 119.

The first home/location 103 illustrated in FIG. 1 may correspond to “My House” 601 illustrated in FIG. 6, for example, and the second home/location 119 may correspond to “Mom's House” 602 or “Brother's House” 603, also illustrated in FIG. 6, for example.

In an embodiment according to the present invention, the electronic devices may comprise associated media storage devices, which may be directly accessible to the MPS 102, for example. In accordance with an embodiment of the present invention, a user may be sitting in front of a media display/consumption device having an associated STB.

The user may be enabled to directly view/capture media (digital images/digital video/digital music, etc.) stored in and/or or played by an electronic device (digital camera/digital camcorder/digital music player, etc) in a manner similar as accessing media stored in a digital media storage server, for example. In an embodiment according to the present invention, the electronic device (digital camera/digital camcorder/digital music player, etc) may also be communicatively connected to a storage server, an STB, a PC, or to a media NAS unit, etc., for example.

In an embodiment according to the present invention, the user of the MPS 102 may employ the remote control 106 to display a channel view, (for example, a media guide) such as the channel view 605 illustrated in FIG. 6 on the TV screen 105. The channel view 605 may comprise a channel listing a plurality of digital images, for example. In the channel view 605, a file comprising digital images may be listed as “Kid's Pictures” 606, for example.

In an embodiment according to the present invention, the user of the MPS 102 may select “Kid's Pictures” 606 on the TV screen 105 by employing the remote control 106. The user of the MPS 102 may employ the remote control 106 to call up and display a list of destination locations in the media exchange network 100 where the display may take place. The displayed list may show, for example, “Mom's House” 602 and “Brother's House” 603 illustrated in FIG. 6, for example.

In an embodiment according to the present invention, the user of the MPS 102 (for example, at “My House” 601) may select a destination location corresponding to the MPS 117 (for example, at “Mom's House” 602) by employing the remote control 106, for example. The user of the MPS 102 (e.g., at “My House” 601) may employ the remote control 106 to initiate sending the file of digital images corresponding to “Kid's Pictures” 606 to the MPS 117 (for example, at “Mom's House” 602) over the media exchange network 100, for example.

In an embodiment according to the present invention, the MPS 102 may request a password from the user, and may also access position/location information for a mobile handset such as the mobile multimedia gateway 111 with GPS receiver 130 shown in FIG. 1, for example. This access of location information may be accessed from the serving wireless infrastructure supporting the mobile multimedia gateway 111 via the broadband network infrastructure 101, or may be retrieved directly from the mobile multimedia gateway 111 using a wireless linking the mobile multimedia gateway 111 and the MPS 102, for example.

In an embodiment according to the present invention, the MPS 102 may then send the password and location information to the MPS 117 for verification. The MPS 117 may then verify the password and location information, and may enable the exchange of multimedia content, in this case the sending of the file of digital images corresponding to “Kid's Pictures” 606 to the MPS 117 (for example, at “Mom's House” 602) over the media exchange network 100.

In an embodiment according to the present invention, the MPS 117 may then receive the file of digital images. The user of the MPS 117 may view (i.e., consume) the file of digital images on the TV screen of the MPS 117, for example.

In accordance with an embodiment of the present invention, a channel (e.g., channel 606 illustrated in FIG. 6) in a channel view (e.g., channel view 605 illustrated in FIG. 6) displayed by an MPS may comprise a pointer to a media content file stored in, for example, a media NAS unit, such as the media NAS unit 108 illustrated in FIG. 1.

In an embodiment according to the present invention, the media content file may be downloaded from the media NAS unit 108 to an MPS, such as for example, the first MPS 102 illustrated in FIG. 1, employing the pointer, and played on a media peripheral, for example, a TV, such as the TV screen 105.

In an embodiment according to the present invention, the media content in the media content file may be streamed directly from, for example, the media NAS unit 108, to a media peripheral, for example, a TV, such as the TV screen 105. In one embodiment of the present invention, the media NAS unit 108 may, for example, make a request for the bandwidth needed for streaming the media content to the MPS 102. In another embodiment of the present invention, the MPS 102 may make such a request before the media NAS unit begins the transfer.

Referring back to FIG. 1, a user of the MPS 102 may select a media content file on the TV screen 105 from a channel view, such as the channel view 605 illustrated in FIG. 6. The channel view 605 may store a pointer that points to the media content file in the media NAS unit 108, for example. Once selected, the media content file pointed to by the pointer may be downloaded to an MPS, such as for example, the MPS 102 illustrated in FIG. 1.

The user of the MPS 102 may consume the media content file (view the media content on the TV screen 105), or push the media content file to another user on the media exchange network 100, for example, the user of MPS 117 at the second home/location 119. In an embodiment of the present invention, a push of media content from the MPS 102 to the MPS 117 may be permitted only after verification of a user password and/or digital certificate, and verification of the location of a mobile handset associated with the user of the MPS 102 has been performed, for example. Although the example provided here is for a push of media content with an MPS, the same approach applies to pull of media content from a remote MPS, and to the push and/or pull from other locations of media content including, for example, network attached storage systems such as NAS unit 108 and 3^{rd} party source/destinations such as 3^{rd} party media provider 127 of FIG. 1.

In accordance with an embodiment of the present invention, media content may be captured by a media peripheral device, such as for example, the digital camera 113 or the digital camcorder 114 illustrated in FIG. 1, in the form of a digital media content file, and delivered to a PC, such as for example, PC 113 illustrated in FIG. 1, via a wired or wireless connection. The digital media content file may then be downloaded from the PC 113 to a channel view (i.e., a media guide or channel view, such as channel view 605 illustrated in FIG. 6) via an MPS via a wired or wireless connection.

In an embodiment according to the present invention, the digital camcorder 114 may be employed to capture digital video of a family vacation, for example. The digital video may be downloaded to the PC 110 via a wireless link between the digital camcorder 114 and the PC 110 at the first home/location 103. The digital video may then be downloaded to the STB 104 via the home network 107 and stored. The digital video may be viewed by the user of the MPS 102 on the TV screen 105, or pushed to another user of the media exchange network 100, such as for example, a user of the MPS 117 at the second home/location 119. When multimedia content is exchanged using, for example, either a push or pull method, the destination or source, respectively, may be capable of verifying the identity of the party performing the push or pull, using password and/or digital certificate information. Verification may also include matching the location of, for example, a mobile handset that is associated with the party requesting the exchange such as, for example, the mobile multimedia gateway 111 with GPS receiver 130. Authentication of the party requesting the exchange (e.g., MPS 102) may be verified by the party receiving the request (e.g., MPS 117), or may be verified by a server such as, for example, the media exchange server 126. In some embodiments of the present invention, this verification may be performed at the same time as a request for the allocation of the network bandwidth to be used for the exchange of the media content.

In an embodiment according to the present invention, the digital video may be downloaded directly to the STB 104, bypassing the PC altogether, via a wired or wireless link between the digital camcorder 114 and the STB 104 at the first home/location 103. The received digital video may also be stored in the STB 104. The digital video may be viewed by the user of the MPS 102 on the TV screen 105, or pushed to another user of the media exchange network 100, such as for example, a user of the MPS 117 at the second home/location 119.

In an embodiment according to the present invention, the digital video may be downloaded directly to a TV display device comprising integrated STB circuitry via a wired or wireless link between the digital camcorder 114 and the TV display device at the first home/location 103. The received digital video may also be stored in the TV display device. The digital video may be viewed by the user of the MPS 102 on the TV display device, or pushed to another user of the media exchange network 100, such as for example, a user of the MPS 117 at the second home/location 119, as described above.

In accordance with an embodiment of the present invention, a user of an MPS may browse 3rd party media stored out on the Internet, pull the 3rd party media, and play it on a TV screen. An embodiment of the present invention may employ the verification techniques described above to enable the pull of media content from such a 3^{rd} party source.

In accordance with an embodiment of the present invention, a user of the MPS 117 at the second home/location 119 may use the remote control 121 to search for 3rd party media on the media exchange network 100, which may include Internet infrastructure and functionality. The user may discover, for example, a music CD provided by the 3rd party media provider 127 and may pull the contents of the music CD to the MPS 117 over the media exchange network 100. Such a pull of media content may, for example, be enabled through the use of a password, a digital certificate, and may employ the location of a user mobile handset device as an additional factor in verifying the authority of the user to perform the media exchange.

In accordance with an embodiment of the present invention, the media content may appear as a channel, such as for example, the channel “Joe's Music” 608 illustrated in FIG. 6.

The user may access the media for consumption using the exemplary method described with respect to FIG. 4 and employing a channel view, such as for example, channel view 605 illustrated in FIG. 6. The 3rd party media provider may bill the user of the MPS 117, or charge an account of the user of the MPS 117 for the media consumption.

In an embodiment of the present invention, a server, such as for example, media exchange server 126 may handle the billing for such media activities.

In accordance with an embodiment of the present invention, various functionalities may be provided on a media exchange network 100 in accordance with various aspects of the present invention.

Functionality on a media exchange network, such as for example, media exchange network 100 illustrated in FIG. 1 may include PC-to-STB and STB-to-STB non-broadcast media exchange via a media guide (channel view) and a remote control.

A media guide such as, for example, the media guide (channel view) 605 illustrated in FIG. 6 lists various scheduled channels of media, and may be displayed on a TV screen or PC monitor, such as for example, the TV screen 105 or PC monitor 109 illustrated in FIG. 1.

Non-broadcast media may comprise personal user media and media generated by friends and family members. Media may be pulled to a STB, such as for example, STB 104, upon media guide selection with queuing, or pushed for local storage prior to media guide selection (no queuing). Media may be pushed to a storage server, and subsequently pulled upon request with queuing.

In accordance with an embodiment of the present invention, audio streaming and video streaming functionality may be provided between a PC and a STB, or vice versa, and between a first STB and a second STB on a media exchange network 100, for example.

Functionality of automatic access and control of media peripheral devices via a firewall and/or universal serial bus (USB) interfaces may be provided with a STB and/or a PC (e.g., an image camera, MPEG 2 video player, a MP3 player) in accordance with an embodiment of the present invention.

Address management functionality of network protocol addresses, such as for example, Internet protocol addresses (IP addresses), media access control addresses (MAC addresses), electronic serial numbers (ESN), for example, may be provided via a media exchange server on the media exchange network 100 in accordance with an embodiment of the present invention. Media migration and access functionality may be provided via a storage server on the media exchange network in accordance with an embodiment of the present invention.

In accordance with an embodiment of the present invention, functionality on the media exchange network 100 may also comprise non-broadcast media exchange between a PC and multiple STB's, or between an STB and multiple STB's via a media guide (channel view) and a remote control.

A user of an MPS, such as for example, the MPS 123 illustrated in FIG. 1 at the place of business 124, may push a file of digital data (for example, a financial spreadsheet) to the MPS 102 and the MPS 117 over the media exchange network 100. The pushed media content may appear on a channel view (media guide) such as the channel view 605 illustrated in FIG. 6. Authentication of a request for exchange of media content between the MPS 123 and the MPSs 102, 117 may be performed as described above.

In accordance with an embodiment of the present invention, the user of the MPS 102 may download the financial spreadsheet to the STB 104 and/or PC 109 via the home network 107, for example, for later viewing. The user of the MPS 117 may store the received financial spreadsheet on the media NAS unit 120 and later access the spreadsheet from the media NAS unit 120 to view on the screen of the MPS 117 (for example, the TV with the MMS) by accessing a channel shown on a channel view displayed on the MPS 117. The exemplary method set forth in FIG. 4 may support such media exchange and consumption.

In accordance with an embodiment of the present invention, sharing of digital media may be accomplished in an automatic and/or automated manner via personal broadcast channels. A media exchange network, such as for example, the media exchange network 100 illustrated in FIG. 1 may coordinate secure and authenticated personal network setup for multiple STB's and/or PC's and provide peripheral device registration and channel set-up functionality in accordance with an embodiment of the present invention.

STB-based and PC-based automatic program construction functionality may be provided with automatic and web based channel routing via the media exchange server in accordance with an embodiment of the present invention. Personal network activity indications, for example, pop-up visual and audio messages, may be delivered to a user via the media exchange server on the media exchange network 100 in accordance with an embodiment of the present invention.

In accordance with an embodiment of the present invention, PC-based and STB-based program editing and construction with channel routing may be provided via a media exchange server on the media exchange network 100. STB-to-STB voice exchange employing packet cable telephony infrastructure may be provided on a media exchange network 100, for example.

In accordance with an embodiment of the present invention, a media exchange server on the media exchange network 100 may support theft prevention and “STB Hotspot” operation of media peripheral devices via registration and security functions. For example, registration of new media peripheral devices with an STB or PC may be performed using the processes described above with respect to the exchange of media content between MPSs. Unauthorized use may be prevented because a user password, a digital certificate, and/or a location of a user mobile handset fails to meet verification criteria such as those described above. Date and time access to media, archived on a storage server (life archival), employing media transcoding engines, for example, may be supported in accordance with an embodiment of the present invention.

In accordance with an embodiment of the present invention, a storage server on the media exchange network 100 may support new media peripheral formats for consumption on STB's or other media peripherals (on-request transcoding), for example.

In accordance with an embodiment of the present invention, non-broadcast commercial media types may be pre-selected and made available for insertion into broadcast media, for example.

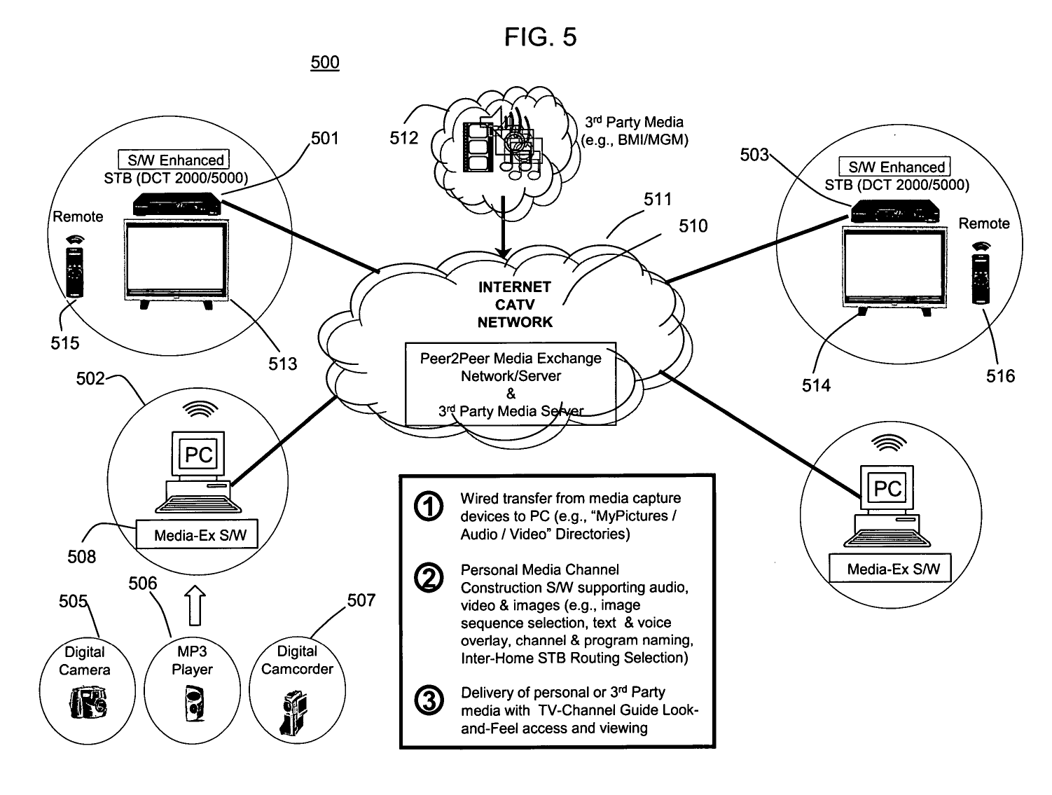

FIG. 5 illustrates a media exchange network 500 for exchanging and sharing media information, in accordance with an embodiment of the present invention. In FIG. 5, a PC 502 and/or an STB 501 may capture various types of media including, for example, digital media from a digital camera 505, an MP3 player 506, and a digital camcorder 507.

Although the peripheral devices in FIG. 5 are illustrated in proximity to the PC 502, the peripheral devices may instead be operatively connected to the STB 501 for exchanging media therewith.

The PC 502 and the STB 501 may be equipped with media exchange software 508 to provide a user interface, distributed storage, and networking capability. The media exchange software 508 may provide personal media channel construction supporting audio, video, images, image sequence selection, text, voice overlay, channel and program naming, and inter-home set-top-box routing selection, for example, in accordance with an embodiment of the present invention.

In FIG. 5, the PC 502 and the STB 501 may interface to a peer2peer (P2P) media exchange network/server 510 on the Internet 511 or in the CATV service provider location (3^{rd} party media server), for example, in accordance with an embodiment of the present invention.

In an embodiment of the present invention, the peer2peer media exchange network/server 510 may comprise a single central server or may comprise a distributed server having software components distributed across various participants of the shared network environment.

In accordance with an embodiment of the present invention, the PC 502 and/or the STB 501 may push the media to a TV display device at a remote location through the peer2peer media exchange network/server 510, for example. The TV display device may also have media exchange software such as the media exchange software 508 installed thereon. Such exchanges may be enabled following verification of, for example, a password, a digital certificate, and/or a location of a user-associated mobile handset like the mobile multimedia gateway 111 of FIG. 1.

The pushed media information may be selected and viewed by a user by way of televisions 513 and 514, for example, which may be interfaced to and/or integrated with the set-top-boxes 501 and 503, for example employing a remote control, such as for example, remote control devices 515 and 516.

The media content may be selected and viewed on the TV display device with a TV-channel guide look-and-feel provided by a channel view (media guide), such as for example, the channel view 605 illustrated in FIG. 6, as displayed by the media exchange software.

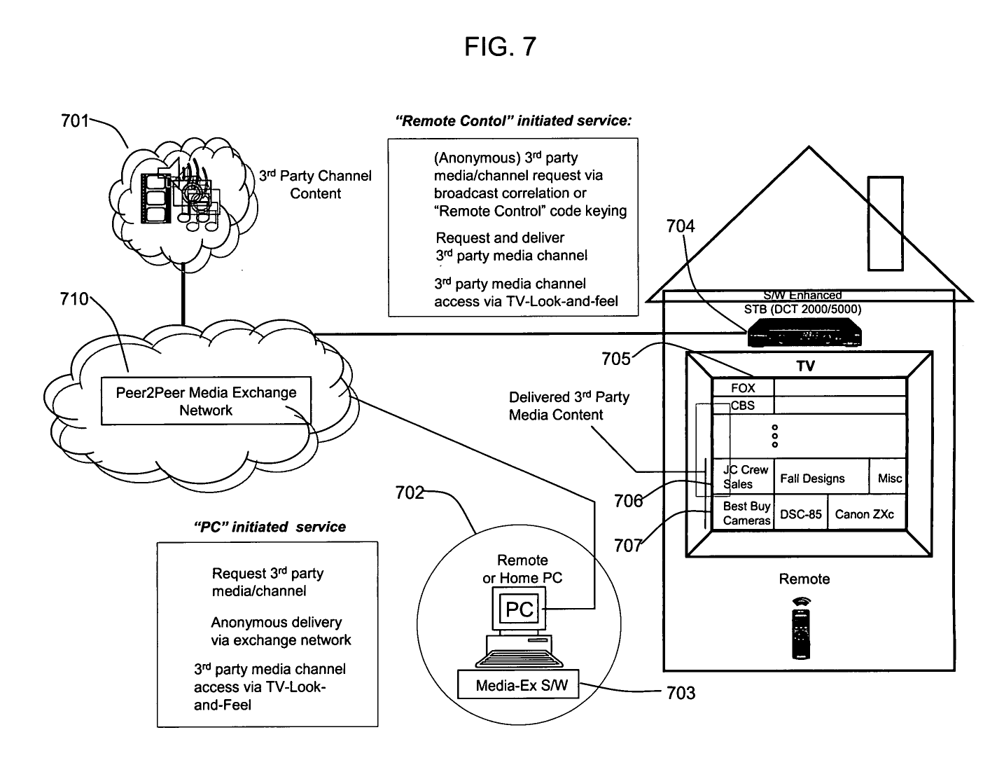

In accordance with an embodiment of the present invention, a 3^{rd} party media provider, such as for example, the 3rd party media provider 512 illustrated in FIG. 5 may also deliver personal and/or 3^{rd} party media. Access to and viewing of such 3^{rd} party media may be provided to users of the PC 502 and/or STB's 501 and 503, for example, via a channel view (media guide) comprising a TV-channel guide look-and-feel, such as for example, the channel view 705 illustrated in FIG. 7 described below. In accordance with an embodiment of the present invention, the delivery of such media content may, for example, be enabled following verification of user authority by a 3^{rd} party media provider such as the 3^{rd} party media provider 512 of FIG. 5, or by a media exchange server such as the media exchange server 510 of FIG. 5.

FIG. 6 and FIG. 7 illustrate examples of two types of media push, personal and third party, respectively, in accordance with embodiments of the present invention. Media exchange software, such as for example, the media exchange software 508 illustrated in FIG. 5 may format the media in a TV-like format and pushes the media from, for example, a home PC 604 or STB at “My House” 601 to a media exchange network/server 609 through, for example, a cable 610, in accordance with an embodiment of the present invention.

The home PC 604 may correspond to, for example, the PC 502 illustrated in FIG. 5. The home PC 604 may also correspond to, for example, the STB 501 illustrated in FIG. 5. A user at “Brother's House” 603 and/or “Mom's House” 602 may access the pushed media information through an installed media boxes 611 and 612 (also known as M-boxes, which are software-enhanced set-top-boxes, for example), at the respective houses.

In an embodiment according to the present invention, the M-boxes 611 and 612 may correspond to, for example, set-top-boxes 501 and 503 illustrated FIG. 5. In an embodiment according to the present invention, the M-boxes 611 and 612 may correspond to, for example, TV display devices having STB circuitry resident therein, for example. The STBs may be separate from the TV and M-Boxes may also be integrated with the STBs.

In an embodiment according to the present invention, the user at Brother's house and Mom's house may each independently select which pushed media to view and at what time, employing their respective media guides (channel views) 613 and 614.

Storage of the pushed media may be on the M-boxes 611 and 612 when the M-box comprises sufficient memory such as, for example, 80 to 120 Gigabytes of memory. Memory/storage may also be provided at various other sites on the media exchange network, such as for example, PC's on the network or servers at a service provider location. Memory/storage may also be provided from the pushing device, such as for example, a PC and/or an STB at “My House” 601.

In an embodiment of the present invention, a wireless interface may be provided between, for example, a digital camera such as the digital camera 505 illustrated in FIG. 5 and an M-box, such as for example, M-box 611, or a digital camera 505 and a PC/STB to provide automatic and/or wireless media capture.

FIG. 7 is a block diagram illustrating an exemplary media push from a 3rd party 701 to a PC 702/STB/M-box 704, for example, in accordance with an embodiment of the present invention. FIG. 7 illustrates a 3rd party 701 communicating via a peer2peer media exchange network/server 710 with a PC 702/STB/M-box 704.

The PC/STB/M-box may comprise media exchange software 703 corresponding to the media exchange software 508 illustrated in FIG. 5. The PC/STB/M-box may support a channel view (media guide) 705 comprising channels 706 and 707, for example. The channel view 705 may correspond to one of channel views 613 and 614 illustrated in FIG. 6, for example. The peer2peer media exchange network/server 710 may correspond to, for example, the peer2peer media exchange network/server 510 illustrated in FIG. 5, for example.

In an embodiment according to the present invention, the media from the 3rd party 701 may be requested by way of the PC/STB/M-box 704 employing a keyboard, such as for example, keyboard 128 illustrated in FIG. 1, and/or a television remote control device, such as for example, the television remote control device 106 illustrated in FIG. 1.

The 3rd party 701 may push the requested media by way of the peer2peer media exchange network/server 710 to the PC/STB/M-box, for example. Any participant having access to the peer2peer media exchange network/server 710 may push or request media information to/from any other participant on the peer2peer media exchange network/server 710. Such exchanges of media content may be contingent upon verification of the authority of the user performing the push or the request. User authority may, for example, be verified using the techniques described above that employ password, digital certificate, and/or matching of a location of a user-associated mobile handset to predetermined valid locations.

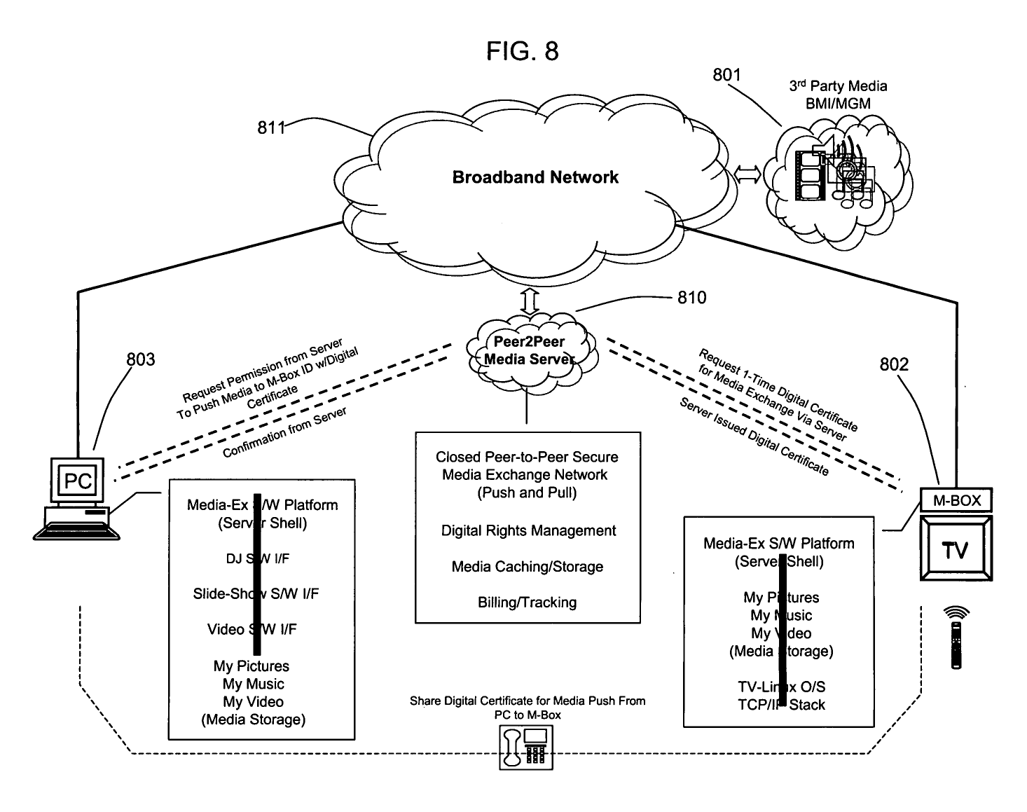

FIG. 8 illustrates an exemplary media exchange network comprising a (PC/STB/M-box) to (PC/STB/M-box) configuration, in accordance with an embodiment of the present invention. The media exchange network configuration illustrated in FIG. 8 may comprise a 3rd party media provider 801, a broadband Internet 811, a peer2peer media server 810, and a PC/STB/M-box.

The broadband Internet 811 may, for example, interconnect the PC 803, the peer2peer media server 810, and the M-box 802 in an embodiment according to the present invention. In FIG. 8, the user of the PC/STB/M-box may choose to push media to the user of another PC/STB/M-box, for example.

In order to permit such a transfer in a secure and private manner, the peer2peer media server 810 may provide a means of assuring the identity of a supplier of media, in the form of a digital certificate or a username/password, for example. Further assurance of the authority of the supplier of the media content to perform requested operations may be provided using information on the location of a mobile handset associated with the user. The sender/receiver may request a digital certificate, a username, and/or a password from the peer2peer media server 810. Current mobile handset location information of the media supplier may also be requested and provided to the peer2peer media server 810, for example.

The digital certificate, username, password, and/or location information may be transmitted to the sender/receiver device. The sender/receiver may request that the peer2peer media server 810 deliver the digital certificate, username/password, and/or location information to the respective sender/receiver device.

In an embodiment according to the present invention, the digital certificate, username/password, and location information requested by the sender receiver device and supplied by the peer2peer media server 810 may comprise a “one-time” digital certificate and/or username/password.

A one-time digital certificate and/or username/password may be valid for a single use, permitting a provider/sender/receiver of media to perform a single transfer of media to the authorizer/sender/receiver.

In an embodiment according to the present invention, the peer2peer media server 810 may be requested to provide digital certificates and/or usernames/passwords for other users of the media exchange network, such as for example, friends and family, or for a 3rd party media provider such as 3rd party media provider 801. The digital certificate and/or username/password may serve to prevent unwanted media pushes from people not known to a user, for example, spam and unsolicited media, such as for example, pornographic media. Additional security may be provided through the verification of the location of a mobile handset that is associated with a user. By verifying a match of location of a user-associated device with a set of predefined or predetermined valid locations, a greater level of security is possible.

In an embodiment according to the present invention, media requests may still be made by a sender/receiver through a normal direct request pathway or through an anonymous request pathway.

It should be noted that although the illustration of FIG. 8 only shows a PC 803 exchanging media with an M-box 802, the present invention is not limited to media exchanges between a PC and an M-box.

For example, the media exchange illustrated in FIG. 8 and described above also applies to exchanges between the following combinations of devices: a PC and another PC; an M-Box and another M-box; an STB and another STB; a TV display device having integrated STB circuitry and software and another TV display device also having integrated STB circuitry and software; a video or image capture device, such as for example, a digital camera and/or camcorder equipped with media exchange software, PC, M-Box, STB and/or TV; and every possible combination of aforesaid devices.

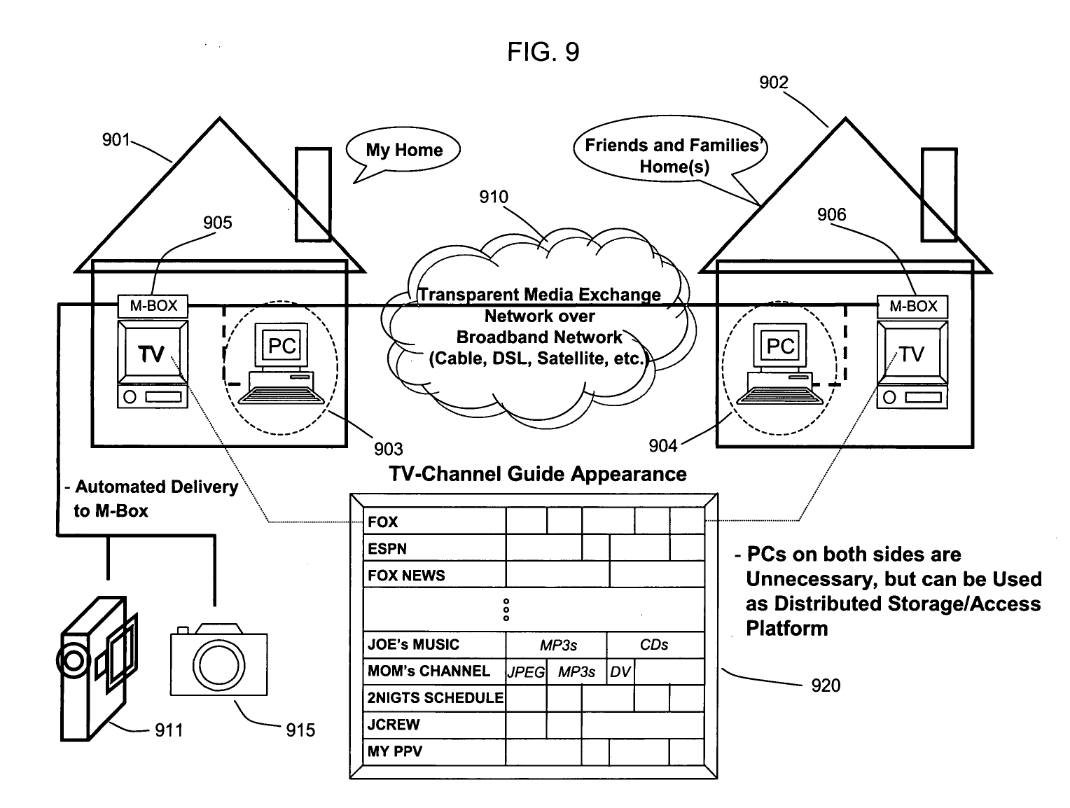

FIG. 9 illustrates an exemplary media exchange network adapted to provide digital media exchange, in accordance with an embodiment of the present invention. FIG. 9 illustrates two homes, “My Home” 901, and “Friends and Families' Home(s)” 902, for example, connected by a media exchange network 910.

Located at “My Home” 901 are an M-box 905 and a PC 903. An STB and/or a TV display device comprising STB circuitry and software may also be located at “My Home”, for example.

Located at “Friends and Families' Home(s)” 902 are an M-box 906 and a PC 904. An STB and/or a TV display device comprising STB circuitry and software may also be located at “Friends and Families' Home”, for example.

Although the PC's 903 and 904 may be provided at both locations for distributed storage and access, they may not necessary. FIG. 9 also illustrates a digital camcorder 911 and a digital camera 915.

A channel view 920 (media guide, TV channel guide look-and-feel interface) may be displayed on one or both of the M-boxes 905 and 906, or in another embodiment of the present invention, on one or both of the PC's 903 and 904.

In another embodiment according to the present invention, the channel guide 920 may also be displayed on a TV display device comprising integrated STB circuitry and software, for example. As shown, the configuration illustrated in FIG. 9 may support automated delivery of media from the digital camcorder 911 and/or the digital camera 915 to the M-boxes 905 and 906, for example.

In another embodiment according to the present invention, the storage devices for digital camcorder 911 and/or digital camera 915 may be directly located in M-Boxes 905, 906, and/or PCs 903, 904, and media captured by digital camcorder 911 and/or digital camera 915 may be pushed to the M-Boxes and/or PCs through a special type of media exchange hardware and/or software.

In an embodiment according to the present invention, the transfer of media may be arranged by a user via the channel view 920 by scheduling a “pull” of the media by one or more of the M-boxes 905 and 906, or PC's 903 and 904, or a push from the digital camcorder 911 or digital camera 915 to one or more of the M-boxes 905 and 906, or PC's 903 and 904.

In an embodiment of the present invention, the PC's 905 and 906 may be used for media consumption, or for distribution and/or storage of the media from the digital camcorder 911 and/or the digital camera 915. The secure and private push of media from the digital camcorder 911 and/or the digital camera 915 may be supported by the use of a digital certificate mechanism, a username/password, and/or location information for a user-associated mobile handset as described above with respect to FIG. 8.

It should be noted that the automated delivery illustrated in FIG. 9 is not limited to the digital camcorder 911 and digital camera 915 media peripherals shown, but may involve the use of alternate or additional media peripherals as well.

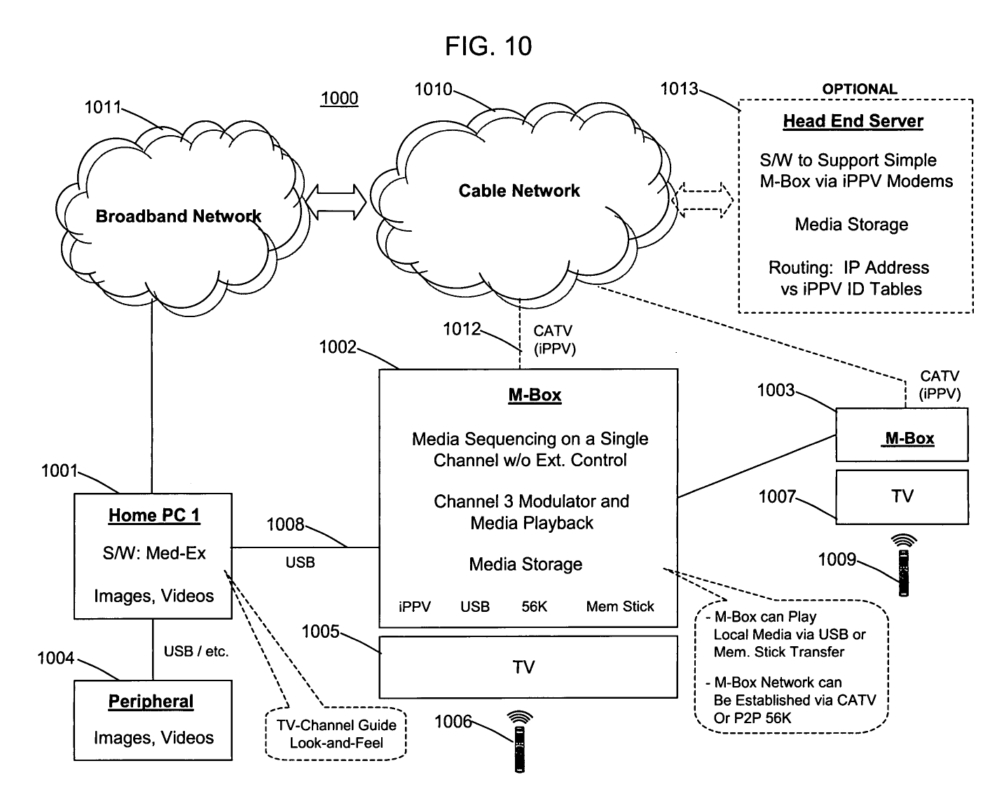

FIG. 10 illustrates an exemplary media exchange network comprising an Internet infrastructure 1011, a cable broadband infrastructure 1010, and a CATV headend server 1013, in accordance with an embodiment of the present invention. FIG. 10 illustrates an embodiment of a media exchange network 1000, such as for example, the media exchange network 100 of FIG. 1.

The media exchange network 1000 may comprise an Internet infrastructure 1011, a cable broadband infrastructure 1010, and a CATV headend server 1013. In addition, the exemplary embodiment of FIG. 10 may comprise a PC 1001, a first M-box 1002, a second M-box 1003, at least one STB, and/or at least one TV display device comprising integrated STB circuitry and software, for example.

The illustrated embodiment may further comprise a media peripheral device 1004 connected to the PC 1001, the first M-box 1002, the second M-box 1003, the at least one STB, and/or the at least one TV display device comprising integrated STB circuitry and software, for example.

In FIG. 10, the media peripheral device 1004 may be connected via a wired link such as, for example, a universal serial bus (USB), or may be linked via a wireless connection, as described above with respect to FIG. 1, for example.

The media peripheral device 1004 may correspond to one or more of, for example, the mobile multimedia gateway 111, the digital camcorder 114, the home jukebox 116, and/or the digital camera illustrated in FIG. 1, for example. The PC 1001 may correspond to PC 101 illustrated in FIG. 1, and the M-boxes 1002 and 1003 may correspond to the set-top-box 104 illustrated in FIG. 1, for example.

In an embodiment according to the present invention, the PC 1001 illustrated in FIG. 10 may comprise media exchange software, such as for example, the media exchange software 508 illustrated in FIG. 5.

As described above, media exchange software 508 may provide a user with a media guide (channel view) interface adapted to facilitate and support the consumption of media, such as for example, still images, audio, and video, for example. The PC 1001 may also comprise an interface to support an interconnection to a co-located M-box, STB, and/or TV display device comprising integrated STB circuitry and software, for example.

In an embodiment according to the present invention, an interconnection, such as for example, USB link 1008 may be employed to interconnect a PC to a nearby M-box, STB, and/or TV display device comprising integrated STB circuitry and software, for example.

The M-box 1002 illustrated in FIG. 10 may be communicatively coupled to other users of the media exchange network via cable television access via CATV link 11012. The M-box 1002 may interface to a user via TV 1005 and remote control 1006.

In an embodiment according to the present invention, the M-box 1002 may support an RF interface to the TV 1005, a 56 Kbps modem, and an internal media storage and an external media storage employing, for example, an external storage means, such as for example, a peripheral memory device, such as for example, a memory stick device made by the Sony Corporation, for example.

In an embodiment according to the present invention, the media exchange network illustrated in FIG. 10 may comprises a second M-box 1003 connected via a CATV link to the cable broadband infrastructure 1010 of the media exchange network 1000, for example.

The TV 1007 and remote control 1009 may provide a user interface for M-box 1003. In addition, the media exchange network 1000 of FIG. 10 may comprise a headend server 1013 having software supporting media storage, interfaces to M-box embodiments, and arrangements for routing of signals to/from the cable broadband infrastructure 1010, where interactive Pay Per View (iPPV) ID addressing may be employed from/to the Internet infrastructure 1011, where Internet protocol (IP) addressing may be employed.

In an embodiment of the present invention, requests for the exchange of media content via the media exchange network 1000 may be enabled by security information comprising, for example, a username, a password, a digital certificate, and/or location information for a user-associated mobile handset like the mobile multimedia gateway 111 of FIG. 1, for example. Although the mobile multimedia gateway 111 is shown in communication with a GPS receiver 130, other methods of determining the position of the mobile multimedia gateway 111 may be employed including, but not limited to methods employing the infrastructure of the wireless network that supports the mobile multimedia handset such as, for example, a cellular network.

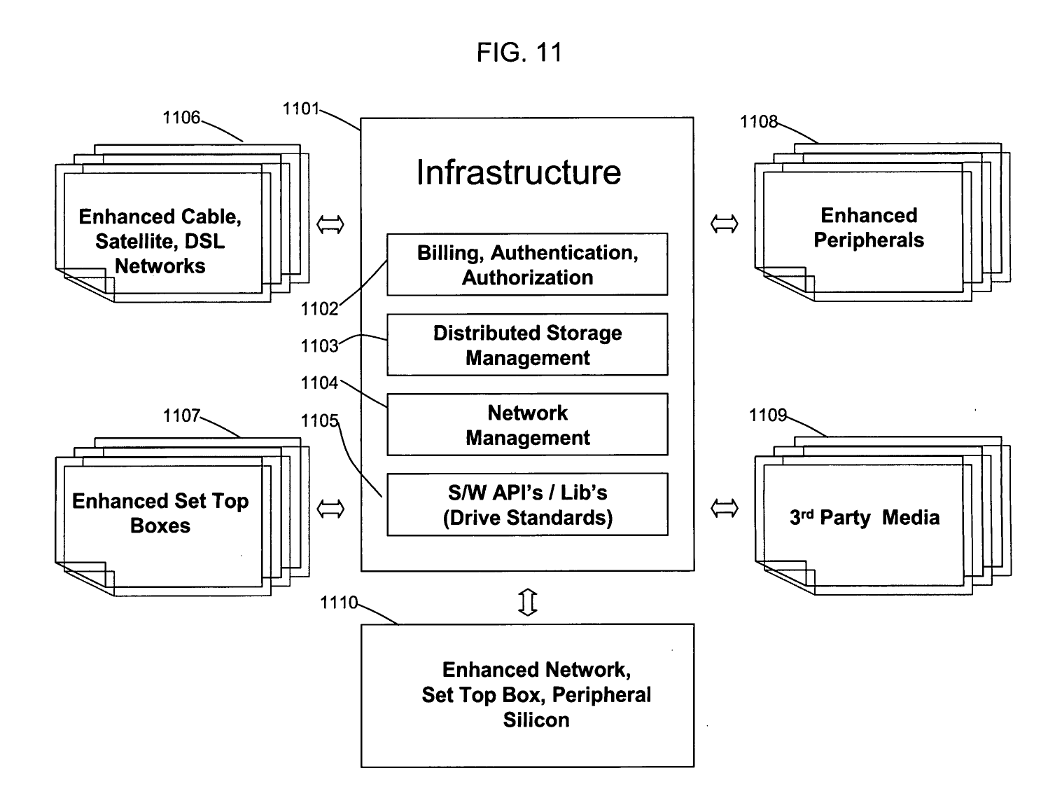

FIG. 11 is a schematic block diagram illustrating various exemplary elements associated with various exemplary embodiments of the present invention. The elements illustrated in FIG. 11 may include infrastructure elements 1101, such as for example, billing, authentication, and authorization 1102; distributed storage management 1103; network management 1104; and software application program interfaces (API's) and libraries 1105.

Additional elements illustrated in FIG. 11 may include enhanced cable, satellite, and digital subscriber line (DSL) networks 1106; enhanced set top boxes 1107; enhanced TV display devices comprising STB circuitry and software; enhanced peripherals 1108; 3rd party media 1109; and enhanced network, set top box, and peripheral silicon (i.e., integrated circuit devices) 1110.

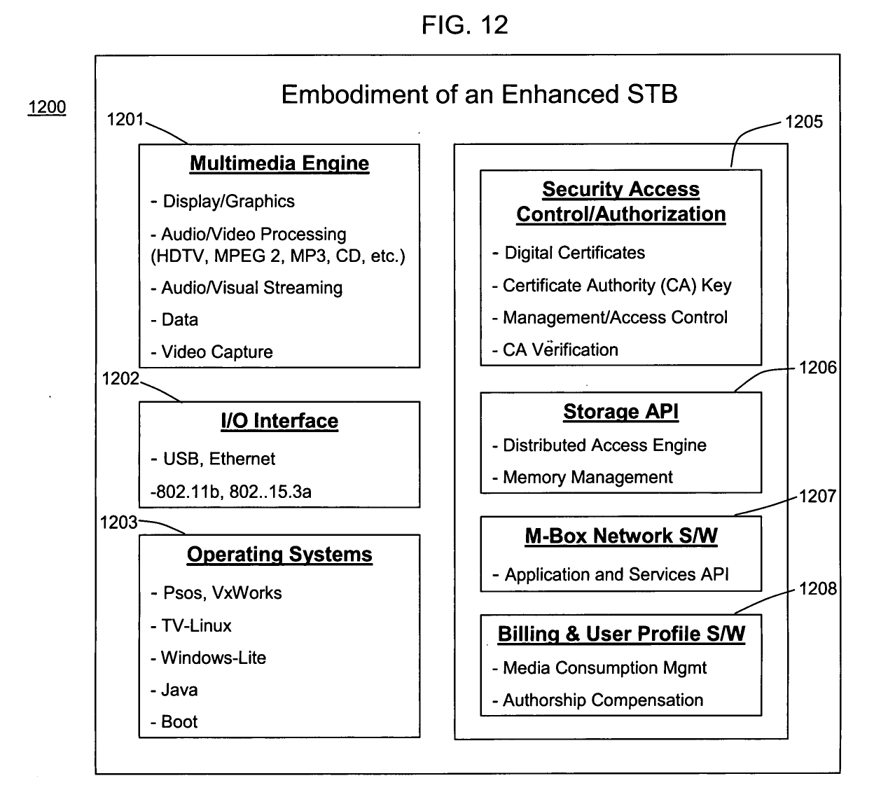

FIG. 12 illustrates the various functional elements of an exemplary enhanced set-top-box 1200, in accordance with an embodiment of the present invention. The enhanced set-top-box 1200 may comprise a multimedia engine functional element 1201, an input/output (I/O) interface functional element 1202, and an operating system (OS) functional element 1203.

The embodiment illustrated in FIG. 12 may also comprise a security access control/authorization functional element 1205, a storage application program interface (API) functional element 1206, an M-box network software functional element 1207, and billing and user profile software functional element 1208.

The multimedia engine functional element 1201 may provide for the display of graphics, such as for example, still images, video, audio, and user interfaces, for example. The multimedia engine functional element 1201 may also support processing of audio and video encoded employing the MPEG2 and MP3 standards, high-resolution television (HDTV) signals, and digital data/audio from compact discs (CDs), for example.

The multi-media engine functional element 1201 may also support capture of audio/video from one or more of the media peripheral devices described with respect to FIG. 1 above.

In an embodiment according to the present invention, the I/O interface functional element 1202 may support universal serial bus (USB) communications described with respect to FIG. 10 above, for example.

In an embodiment according to the present invention, the I/O interface functional element 1202 may also support other forms of communications including, but not limited to, IEEE 802.11b and later forms of wireless local area network (WLAN) communication, and IEEE 802.15.3a and later forms of short-range wireless personal networks, Bluetooth, Ethernet, etc.

This type of short-range network was previously discussed with respect to the link between media peripherals such as the digital camera 113 or digital camcorder 114, and the PC 109 and set top box 104 of FIG. 1.

In an embodiment according to the present invention, the operating system (OS) functional element 1203 may comprise a real-time operating system such as, for example, Psos or VxWorks from WinDriver Systems, Java from Sun Microsystems, Linux, WinCE from Microsoft, and similar operating system environments, for example.

In an embodiment according to the present invention, the security access control/authorization functional element 1205 may provide support for the digital certificate-based mechanism, and/or username/password-based authentication mechanism, described with respect to FIG. 8 above. The security access control/authorization functional element 1205 may also support authentication of a user through the verification of the location of a mobile handset associated with the user, as described previously.

In an embodiment according to the present invention, the security access control/authorization functional element 1205 may also comprise support for management of certificate authority (CA) keys, management and access control, and certificate authority verification, and password authentication.

In an embodiment according to the present invention, the storage application program interface (API) functional element 1206 may comprise support for a distributed access engine and memory management, to provide for the searching and access to storage distributed across a media exchange network 100 illustrated in FIG. 1.

In an embodiment according to the present invention, the M-box network software functional element 1207 may comprise one or more application program interfaces (API's) supporting operation of the M-box described above with respect to FIGS. 6-10.

In an embodiment according to the present invention, the billing and user profile software functional element 1208 may comprise media consumption management-software and authorship compensation supporting billing for and payment of amounts owed to the media providers by users.

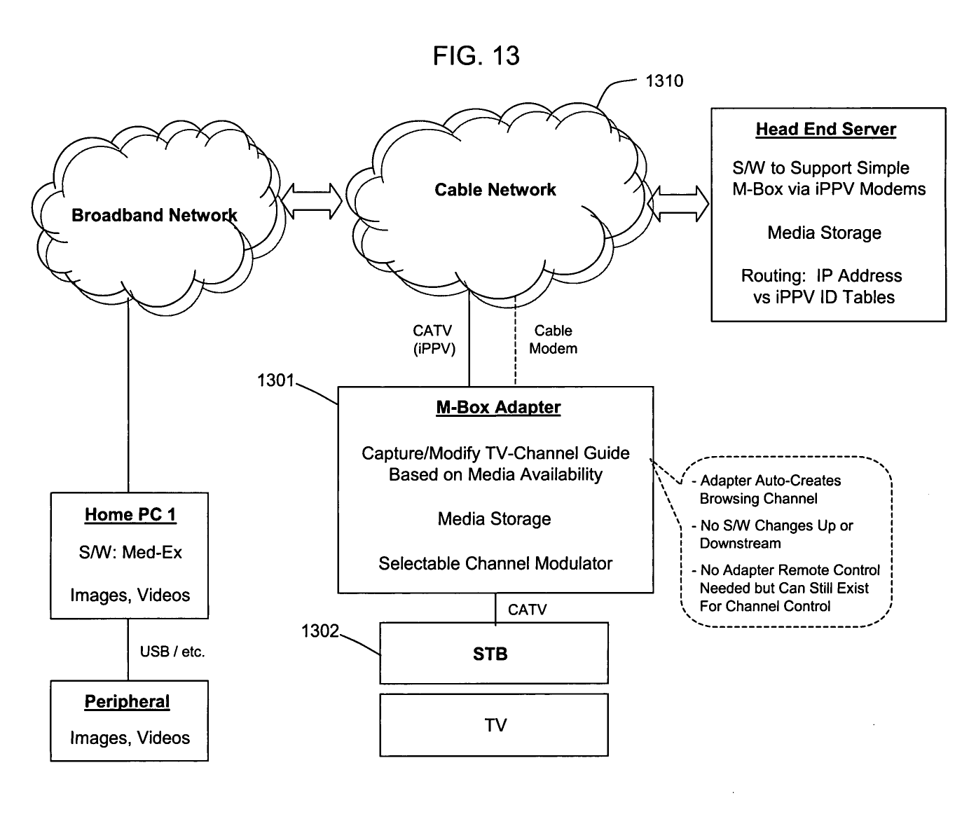

FIG. 13 illustrates an exemplary set-top-box employing an M-box adapter 1301, in accordance with an embodiment of the present invention. The M-box adapter 1301 may provide media storage, a selectable channel modulator, and the capability to capture and modify a TV-channel guide, such as for example, the channel views (media guides) 613 and 614 illustrated in FIG. 6, for example as described above, based upon media availability. The M-box adapter 1301 may interface between the set-top-box 1302 and a broadband cable interface with cable broadband infrastructure 1310 in accordance with an embodiment of the present invention.

In an embodiment according to the present invention, software changes may be required up-stream and/or down-stream from the M-box adapter 1301.

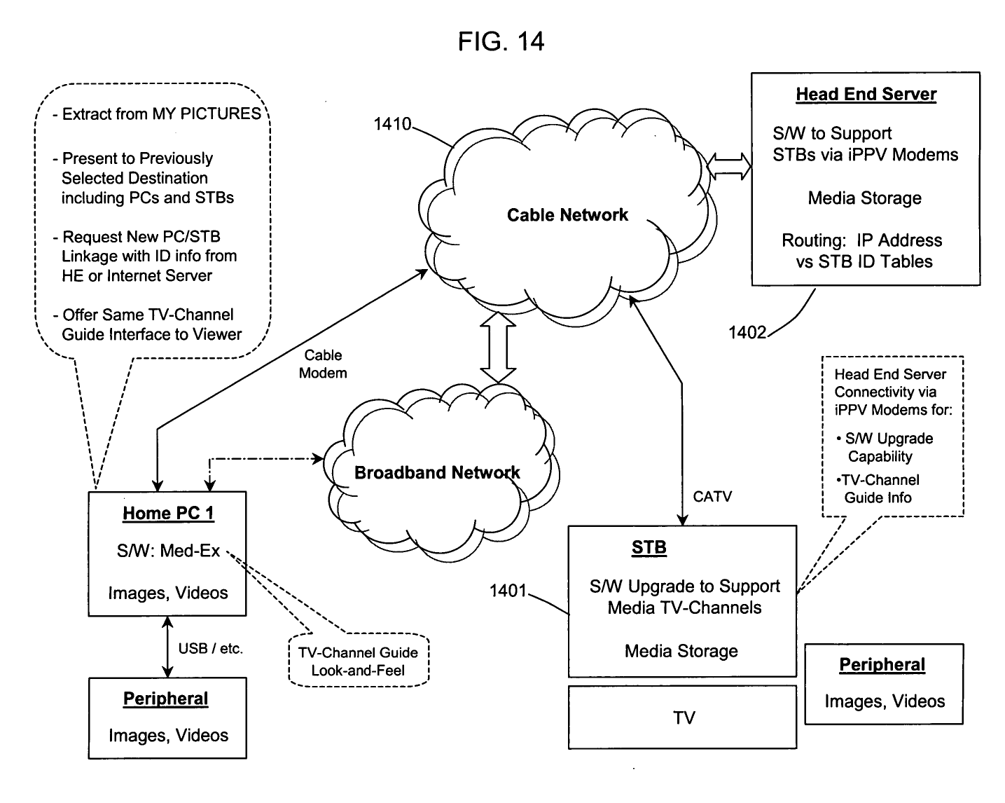

FIG. 14 illustrates an exemplary upgrading of a set-top-box 1401 with software, in accordance with an embodiment of the present invention. A software upgrade may permit the set-top-box 1401 to support media TV-channels using a TV-channel guide look-and-feel interface, such as for example, the channel views (media guides) 613 and 614 illustrated in FIG. 6.

The software upgrade may also permit the set-top-box 1401 to store media and to access the headend server 1402 to support the use of iPPV modems, for example. The software upgrade may permit the set-top-box 1401 to support routing of data between cable iPPV ID-based addresses and Internet infrastructure Internet protocol (IP) addresses employed within the media exchange network infrastructure and to provide for media storage.

The various embodiments described above in at least FIGS. 5-14 enable the features described below. Features of the various embodiments of the present invention may comprise transferring and sharing of digital media from one device/location to another with ease. The transfer and sharing may be transparent to the user because the user is only interested in the entertainment aspects and not interested in the networking aspects.

Various embodiments of the present invention provide a system and method to perform exchanges of multimedia between friends, family members, and 3rd party multimedia providers over a closed, secure media exchange network, such as for example, a CATV multimedia exchange network. The media may include, for example, digital video, digital audio, digital images, digital data, or any form of digital information. The media may also originally be analog information that is converted to digital information for processing in the multimedia exchange network, for example.

Aspects of the present invention also may be found in a system supporting exchange of media. Such a system may comprise a first television display in a first home/location, and a first storage associated with the first home/location adapted to store the media. The first storage may support consumption of the media by the first television display in the first home/location, and may have an associated first network address, for example.

The system may also comprise a second television display in a second home/location, and a second storage supporting storage and consumption of the media by the second television display in the second home/location, the second storage may have an associated second network address.

An embodiment of the present invention may also comprise communications network and server software. The server software may receive a request to identify the associated first and second network addresses, and may respond by identifying the associated first and second network addresses, for example.

The server software may support delivery via the communications network of the media from the first storage to the second home/location for consumption by the second television display. The first and second network addresses may comprise an Internet Protocol address (IP address); a media access control address (MAC address), and an electronic serial number (ESN).

The communications network may comprise at least one of a CATV infrastructure, a satellite network infrastructure, a digital subscriber line (DSL) infrastructure, an Internet infrastructure, an intranet infrastructure, a wired infrastructure, and a wireless infrastructure.

The communications network may be the Internet, for example. The multimedia may comprise at least one of audio, a still image, video, and data, for example. The media may also comprise real-time audio and/or real-time video, for example. Consumption of multimedia may comprise at least one of playing audio, displaying a still image, displaying video, and displaying data, for example. Display of multimedia may comprise making the media available to the senses of an end-user, such as for example, hearing and/or viewing.

Further aspects of the present invention may be found in a system supporting exchange of media. An embodiment of such a system may comprise a first storage in a first home/location adapted to receive/store and/or process/display the media, and having an associated first network/protocol address.

The system may also comprise a second television display in a second home/location adapted to receive/store/process/display the media, and having an associated second network/protocol address. The system may also comprise set top box circuitry in the first home/location. The set top box circuitry may be communicatively coupled to the network to deliver the media from a first home/location to a second home location, for example.

An embodiment of the present invention may also comprise communications network and server software adapted to receive a request to identify one of the associated first and second network/protocol addresses. The server software may respond by identifying the associated first and second network/protocol addresses to support delivery via the communications network of the media from the first storage to the second storage, for example. The media in an embodiment of the present invention may comprise at least one of audio, a still image, video, and data, and the media may comprise real-time video and real-time audio, for example.

In an embodiment of the present invention, the first and second network/protocol addresses may be one of an Internet Protocol address (IP address), a media access control address (MAC address), and an electronic serial number (ESN), for example. Consumption of media may comprise at least one of playing audio, displaying a still image, displaying video, and displaying data, for example.

The communications network may comprise a cable television (CATV) infrastructure, a satellite network infrastructure, a digital subscriber line (DSL) infrastructure, an Internet infrastructure, an intranet infrastructure, a wired infrastructure, and a wireless infrastructure, for example.

In an embodiment in accordance with the present invention, the communications network may be the Internet, for example. The server software may support anonymous media exchange, and may forward media from the first storage at the first location to the second storage at the second location. In an embodiment of the present invention, the server software may reside at a location remote and separate from the first home/location and the second home/location.

Additional aspects of the present invention may be observed in a system supporting exchange of media, where the system may comprise a first storage in a first home/location adapted to store the media, and a second television display in a second home.

The system may also comprise set top box circuitry, in the first home/location, communicatively coupled to deliver the media from the first storage to the second television display for consumption. In addition, the system may comprise a communications network, and server software adapted to coordinate delivery of the media from the first storage to the set top box circuitry at the second home location.

In an embodiment of the present invention, the media may comprise at least one of audio, a still image, video, and data, and the media may comprise real-time video. Consumption of media in accordance with an embodiment of the present invention may comprise at least one of playing audio, displaying a still image, displaying video, and displaying data.

The communications network may comprise at least one of a cable infrastructure, a satellite network infrastructure, a digital subscriber line (DSL) infrastructure, an Internet infrastructure, an intranet infrastructure, a wired infrastructure, and a wireless infrastructure. The communications network may be the Internet, for example. In an embodiment of the present invention, the server software may support anonymous media exchange.

Features of various embodiments of the present invention may comprise a personal media storage network for sharing images, video, and music with friends and family and for selected third party content. Digital media may be accessible via an interactive TV channel guide interface requiring no learning curve and providing mass-market appeal.

Network set-up and TV channel guide interaction may be accomplished via a TV remote control device. A common channel guide interface may be made available on set-top-boxes, satellite, PC, and TV display device having integrated STB circuitry and software, for example.

Other features include integrating media generating devices at network peripherals. Automated peripheral media access and peripheral control may be provided via an inter-home (personal) network.

Inter-home roaming may be supported based upon authentication via digital certificates and/or usernames/passwords. Additional security may be provided by verifying a location of a mobile handset associated with a user at the time of access. Personal channels may be constructed, such as for example, a “Mom” channel, life archival selections, auctions, sales, commercials, classics, music, sitcoms, for example.

Certain embodiments of the present invention may provide infrastructure to support features, such as for example, authorship and media rights management. A set-top-box may work in conjunction with a server and a digital certificate, username/password, and/or location information of a user-associated mobile handset. The user may be operating on a closed and secure platform, for example.

Shared inter-home media experiences may be provided by embodiments of the present invention, such as for example, a multi-home media event with personal PIP/Audio exchange between family members at different locations and single user control, for example.

The service provider on the display device at the user home, for example, may provide monthly billing, pay-per-view billing and/or pay-per-listen billing, for example, interactively in accordance with an embodiment of the present invention.

An embodiment of the present invention may provide a software platform for PCs and set-top-boxes (STBs) that enables personal media (pictures, video, music) channel construction, push, pull, and TV-channel guide look-and-feel access and viewing across a secure peer2peer IP/CATV network.

Media may be instantly pushed and/or pulled to/from a PC or STB, to another STB in a pre-established friends and family network, for example. The media exchange network may provide secure distribution of copyrighted third party content with billing support.

In accordance with an embodiment of the present invention, for an in-home network infrastructure, a multi-platform media storage network may extend to home PCs, set-top-boxes, personal video recording devices (PVR), media players, and cameras, for example.

Easy access may be provided from an M-box/STB to any stored media, for example. The ability to remotely access any media or drive in the M-box, STB, PC, or other appliances using a TV display as a monitor may also be provided.

In accordance with an embodiment of the present invention, for inter-home network infrastructure, a set-top-box/PVR engine may be enhanced (M-box) with additional operating system (Windows-lite, TV-Linux, etc.), TCP/IP, and HTTP stacks. M-boxes/STBs may connect to one another via broadband access networks such as cable and DSL, for example.

Stored media (video, audio, music, etc.) may appear like regular TV channels (similar to PPV listings) to authorized connected users. M-box connection and networking aspects may be transparent to connected users, for example, with complete TV-like feeling provided.

In accordance with an embodiment of the present invention, IP exchange, authorization, and authentication may also be provided. Peripheral devices (cameras, phones, etc.) and M-box/STB associations may be made based upon digital certificate authorization and authentication.

Each device may be provided with a “certificate key” (common to all devices), and a “device certificate” (unique for each device) where the M-box/STB may validate each device certificate with the “certificate key”. The peripheral devices may associate with a root M-box/STB or any other M-box/STB without further set-up the devices may be plug and play, for example.

Any peripheral device that may be connected directly to a root M-box/STB may also do so through any other M-box/STB, for example. The M-Box/STB may be provided with software adapted to identify, negotiate communication protocols, and facilitate interaction with a plurality of peripheral devices. This authentication may also be achieved by employing username/password-based authentication along with, or as an alternative to, digital certificate-based authentication.

IP exchange, authorization, and authentication may be based upon a remote control box number or an IP address and password in accordance with an embodiment of the present invention. IP exchange, authorization, and authentication may be through an Internet PC and/or a cable service provider employing an interactive M-box/STB sync (i.e., handshaking).

A telephone interface may also be provided, for example, by manually entering an access number or employing another M-box interaction, a telephone may be communicatively connected thereto. There may be, for example, a cable service provider company to cable service provider bridge/common M-box/STB specifications and/or tables.

In accordance with an embodiment of the present invention, provided personal home media channels may appear like regular TV channels or PPV channel listings (e.g., “Mom channel”, “Brother channel”). Channel listings may be sorted by media type, category, time and date, previously viewed, content, maturity level, security level, urgency, confidentiality, for example, with options to “play only/play-copy-store/request-copy”.

Stored media in a root M-box/STB may automatically appear on other authorized M-boxes/STBs on the appropriate home media channels. A user may select from a home media channels list for viewing rights. Contents may be viewed once or multiple times with options to destroy/erase/save/edit/modify/merge the media, for example. A view once/multiple times certificate may be obtained or the rights may be purchased according to an embodiment of the present invention, for example.

In accordance with an embodiment of the present invention, in the M-box/STB network infrastructure, a personal M-box/STB network may be provided supporting broadband access, such as for example, cable, DSL, satellite, and dial-up. Personal M-box/STB network creation and maintenance may also be provided.

Linkage architecture may be provided for all personal M-box/STB networks. Remote/home access to a personal M-box/STB network via the Internet and PC for media scheduling/channel line-up, purchasing, and delivery may also be provided, for example. SPAM filtering and a firewall may also be provided in the M-box/STB network infrastructure, for example.

Embodiments of the present invention may provide M-box/STB peripheral and storage support. Peripherals may be associated with a home M-box/STB. Peripheral roaming access/authorization/billing to any M-box/STB may also be provided.

A distributed home/personal M-box/STB network storage/access with “lifetime” archival (storage infrastructure) may be provided. Personal media migration into the infrastructure network, servers, hosting, and caching may be provided.

Instant media availability throughout the personal M-box/STB network, upon home M-box/STB content creation/authorization, may be provided. A media storage network may extend from the M-box/STB peripherals through the entire M-box/STB network.

A TV-channel look-and-feel may be provided to access media content in accordance with an embodiment of the present invention. For example, a PPV look-and-feel may provide the ability to queue start times, for example.

Channel listings may be sorted by media type, category, creation/availability date, previously viewed, etc. with options to “play_only”, and/or “play_copy_store”, and/or “request copy”. A computer look-and-feel may also be supported in accordance with an embodiment of the present invention.

A cable/headend multimedia service provider may coordinate billing, playback, authorization, scheduling, and media rights in accordance with an embodiment of the present invention. An author/media creator may establish home media channel viewing rights, for example.

In an embodiment according to the present invention, a personal media channel may be constructed from information on an M-box/STB, peripheral, and/or Internet PC media storage, belonging to a user, friend, and/or family member in accordance with an embodiment of the present invention. Embodiments of the present invention may support Mom/Brother/Family/Friends/Kids/Students/Work/Activities etc. channels, for example.

Instant availability of created media via peripherals across personal channels in the M-box/STB network may also be provided. Media search and browsing capability and an individual's life archival channel storing all media may also provided.

In an embodiment according to the present invention, a vendor media channel may be constructed from a multitude of vendor M-boxes/STBs, peripherals, Internet, and cable head-end (service provider) stored media, for example, in accordance with an embodiment of the present invention.

Vendor media and vendor-associated media may be identified via searching and browsing via an M-box/STB/Internet PC, for example. Vendor video/audio/image databases with billing and tracking may also be supported. The vendor databases may include, for example, new releases, classics, thrillers, MGM, BMI, sports, and news, for example.

In accordance with an embodiment of the present invention, a vendor may pre-construct a media channel selection. Pre-constructed media channels may be selected from a vendor M-box/STB, peripheral, Internet, or cable head-end (service provider) media storage. An auction channel may be supported with a user-driven QVC-like TV channel interface, for example.

In an embodiment according to the present invention, vendor sales channels with user selectable content may also be provided. A vendor may support pre-construction for a given user on-the-fly based upon a user profile, user requests, and user restrictions, for example.

Access via a search engine, reference (routing) number (identified in a TV commercial or from internet PC web page browsing) may be supported. An M-box/STB may receive a reference number via remote control (number entry or new request button associated with a current commercial) or via Internet PC forwarding, for example.

Automatic commercial/advertisement insertion by pre-selection or user profile may be supported. Billing via PC Internet web page interaction and/or PPV look-and-feel may be supported, for example.

An audio look-and-feel may be offered and may have the same look-and-feel as TV music channels in accordance with an embodiment of the present invention. Direct audio amplifier delivery via an M-box/STB may be provided (Aux. Dongle, Low power FM modulation).

MP3 interchange between any two media player M-box/STB peripherals may be provided through a personal M-box/STB network and beyond. Streaming support of M-box/STB audio/video/peer-to-peer/master-slave may be provided.

In accordance with an embodiment of the present invention, an STB/enhanced TV display apparatus as set forth above may be supported. An auxiliary M-box/STB adapter may be offered that is attachable to the STB to provide additional functionality.

In accordance with an embodiment of the present invention, STB's may be supported with a software upgrade at a cable headend and STB push capability from a user/friend/family/third party internet PC or from a friend/family/third party M-box/STB with an auxiliary M-box/STB adapter. Low-bandwidth images and audio may be supported.

A cable headend may deliver a software upgrade with integrated personal media as part of the user interface to provide a menu sequence that appears as a channel. For example, when a user selects “Mom's channel”, for example, a menu sequence of Mom's images may be presented to the user for viewing.

In accordance with an embodiment of the present invention, media consumption from local or remote storage may create a billing event charged through a cable company as PPV or PPlisten, or may be charged via a PC account set-up and/or a credit card or other payment source.

Collections may be delivered to the author from the cable company, for example. Media copyright piracy prevention and usage tracking/consumption/certificates may be provided. Contents may be viewed once or multiple times with an option to destroy/erase/modify/edit/store the media, for example.

M-box/STB personal billing profiles, processing, and authorization may be provided via the cable network. An M-box/STB credit card/smart card/cell phone/PDA-purchasing peripheral may be provided and employed, for example. A billed party may be the media consumer or the party delivering the media or arranging the media delivery, for example.

Other features supported by embodiments of the present invention may comprise a real-time video/audio inter-home media experience (personal picture-in-picture (PIP), multicasting), media metadata support and M-box/STB display, marketing/user profiling support, home appliance access, as part of home M-box/STB network, cell-phone call routing via home M-box/STB, and screen saver TV mode, for example.

Aspects of the present invention may be found in a system and method provide for the secure exchange and sharing of media between, for example, family members and friends in an efficient, secure, user-friendly, and economically viable manner over a closed and secure media exchange network employing a multimedia processing system (MPS) with a remote control and TV screen, for example, in accordance with an embodiment of the present invention.

Aspects of the present invention may be found in a digital TV display device comprising built-in digital multimedia-program decoding and multimedia-program display hardware, firmware, and/or software functionality, for example, a TV set having integrated STB functionality.

The digital TV display device may also comprise plug and play functionality integrated into the device operating system. The digital TV display device may also comprise security firmware/software and associated security hardware providing identity recognition and authorization authentication before permitting display of received multimedia.

Aspects of the present invention may be found in a digital TV display device adapted to conveniently interact with a plurality of consumer electronic devices, for example.

The plurality of consumer electronic devices may comprise one or more of digital program recorders, video cassette players, video cassette recorders, digital video disc players, digital video disc recorders, MP3 audio players, mobile cellular handsets, wired telephones, wireless cellular handsets, personal digital assistants, audio tape players, audio tape recorders, compact disc players, compact disc recorders, digital still cameras, digital video cameras, and computer gaming consoles, for example, operating in conjunction with a media exchange system.

Aspects of the present invention may also be found in a plurality of personal multimedia-program recording applications.

Personal multimedia-program recording applications may be defined as end-user initiated and/or end-user issued commands to consumer electronic devices, such as, for example, a STB, a digital TV display device, or any of the personal consumer electronic devices set forth above, to record a requested channel, transmission, or multimedia-program being broadcast at a later time, for example.

The electronic devices set forth above may also be adapted to prompt an end-user to suggest commands and to select commands appropriate to particular end-users' viewing preferences, for example.

For example, in an embodiment according to the present invention, personal multimedia-program recording applications may comprise, for example, an electronic device prompting an end-user to record a first multimedia-program and a second multimedia-program (or a plurality of multimedia-programs thereof) by interacting with the electronic device prior to the time a program broadcast is to occur, thus removing the necessity of the end-user being physically present when a program begins to initiate a recording procedure.

In an embodiment according to the present invention, an end-user may choose to watch multiple recorded programs at one or a plurality of later time(s). In an embodiment according to the present invention, the electronic device may prompt the end-user to issue/select playback command(s) to initiate playback of recorded multimedia-programs at particular date(s) and time(s).

In an embodiment according to the present invention, responding to a message/prompt delivered by the electronic device may comprise pressing at least one button or key on a remote control device, the electronic device, and/or an associated peripheral electronic device, for example.

In an embodiment according to the present invention, responding to a message/prompt delivered by the electronic device may comprise pressing a sequence of buttons or keys on the remote control device, the electronic device, and the associated peripheral electronic devices, for example.

In an embodiment according to the present invention, responding to a message/prompt delivered by the electronic device may comprise entering a password and/or a username on the remote control device, the electronic device, and/or the associated peripheral electronic devices.

In an embodiment according to the present invention, responding to a message/prompt delivered by the electronic device may comprise entering a particular response to an interactive question delivered by the electronic device upon the remote control device, the electronic device, and/or the associated peripheral electronic devices. The response to the interactive question may comprise a code, text, a number, or some other pre-set or assignable information that an end-user may be able to easily remember.

In an embodiment according to the present invention, responding to a message delivered by the electronic device may comprise employing a biometric authentication security technique via at least one of the remote control device, the electronic device, and/or the associated peripheral electronic device.

In an embodiment according to the present invention, a biometric authentication security technique may comprise at least one of a fingerprint analysis, an iris or other eye scanning analysis, a facial recognition technique, a voice recognition technique, receiving a wireless radio frequency signal transmitted by an implanted micro-device or a wearable micro-device or chip, etc. for example.

The associated peripheral electronic device may comprise at least one device adapted to carry out at least one of the above-mentioned biometric authentication security techniques.

In an embodiment according to the present invention, the end-user may be prompted to enter a username/password, for example, comprising a sequence of buttons/keys on a remote control device, for example.

The end-user may also be prompted to enter an alphanumeric value(s) displayed on the display device/entity. The electronic device may randomly generate an alphanumeric value(s) displayed on the display device/entity, for example.

Aspects of the present invention may be found in a digital circuit board or application specific integrated circuit (ASIC) integrated into an electronic device for performing security and biometric authentication techniques. In an embodiment according to the present invention, the security and biometric authentication techniques may be provided as firmware/software in an integrated circuit, a programmable logic device, or a chip and may be adapted to interact with a biometric authentication hardware device for example.

The integrated circuit, programmable logic device, or chip may be installed in the STB, the digital TV product, and/or any other associated peripheral electronic device, as set forth above.

Aspects of the present invention may be found in security and biometric authentication techniques implemented in stand-alone STBs. In an embodiment according to the present invention, the STBs may comprise mobile wireless enabled STBs.

In an embodiment according to the present invention, end-user settings and/or preferences may be stored in a non-volatile memory device, for example, a FLASH memory (NAND-type flash, NOR-type flash, and/or a combination NAND/NOR-type flash memory component) or an additional secondary storage device, such as, a hard drive, for example.

In an embodiment according to the present invention, the electronic device may be adapted to prompt the end-user to press some button(s)/key(s), a sequence of button(s)/key(s), a password, a username, an alphanumeric value displayed on the display device/entity (and/or generated randomly by the electronic device), or a responsive value through a remote control device, for example, at predetermined or random intervals of time.

Aspects of the present invention may be found in a plurality of security and biometric authentication techniques and/or devices controlled by the electronic device, such as for example, an STB. The security and biometric authentication techniques and devices may be plug and play devices, for example.

In an embodiment according to the present invention, the electronic device may prompt the end-user to provide/select a plurality of commands associated with a plurality of multimedia-programming-related events. The electronic device may be adapted to store and evaluate the commands, determine appropriate security states/modes to efficiently perform the commands, enable/disable and initiate the determined appropriate security states/modes, and carry out end-user issued/selected program-related commands employing appropriate security features.

In an embodiment according to the present invention, an end-user may be prompted to respond to a security message/prompt transmitted by the electronic device. In an embodiment according to the present invention, responding to the security message/prompt delivered by the electronic device may comprise pressing a button or a key on a remote control device, the electronic device, and/or an associated peripheral electronic device.

In an embodiment according to the present invention, responding to a security message/prompt delivered by the electronic device may comprise pressing a sequence of buttons and keys on the remote control device, the electronic device, and/or the associated peripheral electronic device, for example.

The peripheral associated electronic device may comprise an STB, a digital TV product, a fingerprint reading device, a voice recognition device, an eye scanning device, other biometric identification devices, a identification card reader, a bar code reader, and a receiver adapted to receive a signal transmitted from an implantable or wearable micro-device, such as an implantable microchip and miniature radio frequency (RF) transmitter ad/or a radio frequency identification device (RFID), for example.

In an embodiment according to the present invention, responding to a security message/prompt delivered by the electronic device may comprise employing a biometric authentication technique via the remote control device, the electronic device, and/or the associated peripheral electronic device.

In an embodiment according to the present invention, the electronic device may be provided with additional security features, such as for example, parental controls. In an embodiment according to the present invention, parental controls may comprise an analysis of multimedia content to determine whether the content contains information designed for viewing by mature audiences, teen audiences, or information appropriate for all audiences, for example.

In an embodiment according to the present invention, the multimedia content may be flagged (have a preset flag in a header thereof) or identified in some other way as being for mature audiences, for example, wherein identification (secure biometric authentication) may be required to permit the media to be viewed.

In an embodiment according to the present invention, additional security may comprise individual specific media content. For example, a spouse may send a personal media to a remote other spouse. The personal media may be protected from viewing by anyone other than the intended viewer by prompting a viewer to identify themselves and submitting to security measures (e.g., biometric identification), such as for example, those set forth above.

In an embodiment according to the present invention, additional security features may be employed for confidential business media, banking media, government media, military media, and law enforcement-specific media content. For example, an employer may transmit a confidential media to a remote employee. The confidential media may be protected from viewing by anyone other than the intended viewer by prompting to identify themselves and submitting to security measures, such as for example, those set forth above.

Aspects of the present invention may be found a secure media exchange network comprising a plurality of electronic devices adapted to securely communicate via the network and a plurality of peripheral electronic devices adapted to communicate with the plurality of electronic devices. Media originating on a first peripheral electronic device may be transmittable to a first electronic device. The first electronic device may be adapted to securely transmit the media to a second electronic device via the network. The media may be consumable by a media consumption device associated with the second electronic device.

In an embodiment according to the present invention, the media exchange network may be adapted to simultaneously share media with the plurality of electronic devices, wherein sharing the media simultaneously may comprise transmitting a media content from one electronic device to multiple other electronic devices simultaneously via the media exchange network.

In an embodiment according to the present invention, the plurality of peripheral electronic devices may comprise one of a digital/analog media recording device, a digital/analog video cassette player, a digital/analog video cassette recorder, a digital video disc player, a digital video disc recorder, a digital MP3 audio player, a digital/analog telephone, a wireless cellular handset, a personal digital assistant, an analog audio tape player, an analog audio tape recorder, a digital compact disc player, a digital compact disc recorder, a digital still camera, a digital video camera, and a digital gaming console.

In an embodiment according to the present invention, the plurality of electronic devices and the network may be adapted to securely communicate via one of a wire, a cable, an optical fiber, and wirelessly in two-way communication.

In an embodiment according to the present invention, the media may comprise one of audio, video, text, images, documents, Internet communication, and wireless telephony.

In an embodiment according to the present invention, the plurality of electronic devices may comprise one of a personal computer (PC), a set-top-box (STB), a television (TV) display-device comprising STB circuitry and software, and a media box (M-Box).

In an embodiment according to the present invention, the network may further comprise a broadband infrastructure comprising at least one of the Internet infrastructure, a copper cable infrastructure, a fiber optic cable infrastructure, a wireless telephone infrastructure, a wired telephone infrastructure, a direct subscriber line (DSL) infrastructure, an Over-The-Air (OTA) infrastructure, and an intranet infrastructure.

In an embodiment according to the present invention, the media consumption device may comprise a device adapted to display one of video, audio, text, images, and digital information to a media receiving end-user.

In an embodiment according to the present invention, secure media transmission may comprise one of security techniques and associated security hardware.

In an embodiment according to the present invention, security techniques and associated security hardware may comprise one of a secure set-top-box, a secure digital TV product, a fingerprint reading device and associated method, a voice recognition device and associated method, an eye scanning device and associated method, a username/password-based authentication device and associated method, a digital certificate-based authentication device and associated method, a smart card based authentication device and associated method, a GPS based authentication device and associated method, an identification card reader and associated method, a bar code reader and associated method, and a receiver adapted to receive a signal transmitted from one of an implantable and a wearable micro-device and associated respective methods.

Aspects of the present invention may comprise an electronic device adapted to securely transmit media via a media exchange network. The electronic device may comprise a secure communicative interface to the media exchange network and a communicative interface to a plurality of peripheral electronic devices. Media originating on a first peripheral electronic device may be transmittable to the electronic device. The electronic device may be adapted to securely transmit the media to a remote electronic device via the network. The media may be consumable by a media consumption device associated with the remote electronic device.

In an embodiment according to the present invention, a media exchange network may be adapted to simultaneously share media with the plurality of electronic devices, wherein sharing the media simultaneously may comprise transmitting a media content from one electronic device to multiple other electronic devices simultaneously via the media exchange network.

In an embodiment according to the present invention, the plurality of peripheral electronic devices may comprise one of a digital/analog multimedia-program recorder, a digital/analog video cassette player, a digital/analog video cassette recorder, a digital/analog video disc player, a digital/analog video disc recorder, a digital/analog MP3 audio player, a digital/analog telephone, a wireless cellular handset, a personal digital assistant, an digital/analog audio tape player, an digital/analog audio tape recorder, a digital/analog compact disc player, a digital/analog compact disc recorder, a digital/analog still camera, a digital/analog video camera, and a digital/analog gaming console.

In an embodiment according to the present invention, the electronic device may be adapted to securely communicate via one of a wire, a cable, an optical fiber, and wirelessly in two-way communication with the media exchange network.

In an embodiment according to the present invention, media may comprise one of audio, video, text, images, and documents.

In an embodiment according to the present invention, the electronic device may comprise one of a personal computer (PC), a set-top-box, a television (TV) display-device comprising STB circuitry and software, and a media box (M-Box).

In an embodiment according to the present invention, the media consumption device may comprise a device adapted to display one of video, audio, text, and digital information to a media receiving end-user.

In an embodiment according to the present invention, the electronic device may be adapted to securely communicate with a media exchange network comprising a broadband infrastructure, the broadband infrastructure comprising at least one of the Internet infrastructure, a copper cable infrastructure, a fiber optic cable infrastructure, a wireless telephone infrastructure, a wired telephone infrastructure, a direct subscriber line (DSL) infrastructure, an Over-The-Air (OTA) infrastructure, and an intranet infrastructure.

In an embodiment according to the present invention, secure media transmission may further comprise security techniques and associated security hardware.

In an embodiment according to the present invention, security techniques and associated security hardware may comprise one of a secure set-top-box, a secure digital TV product, a fingerprint reading device and associated method, a voice recognition device and associated method, an eye scanning device and associated method, an identification card reader and associated method, a bar code reader and associated method, a password-based authentication device and associated method, a digital certificate-based authentication device and associated method, a smart card-based authentication device and associated method, a GPS-based authentication device and associated method, and a receiver adapted to receive a signal transmitted from one of an implantable and a wearable micro-device and associated respective methods.

Aspects of the present invention may be found in a method of securely exchanging media over a media exchange network. The method may comprise receiving media in a first electronic device from a peripheral electronic device, securely transmitting the received media from the first electronic device to a second electronic device via the media exchange network, securely receiving the transmitted media at the second electronic device, transmitting the media from the second electronic device to a media consumption device, and consuming the media.

In an embodiment according to the present invention, the method may also comprise simultaneously sharing media with the plurality of electronic devices via the media exchange network, wherein simultaneously sharing the media may comprise simultaneously transmitting a media content from one electronic device to multiple other electronic devices via the media exchange network.

In an embodiment according to the present invention, the peripheral electronic device may comprise at least one of a digital/analog media player/recorder, a digital video cassette player, a digital video cassette recorder, a digital video disc player, a digital video disc recorder, a digital MP3 audio player, a digital/analog telephone, a wireless cellular handset, a personal digital assistant, an analog audio tape player, an analog audio tape recorder, a digital compact disc player, a digital compact disc recorder, a digital still camera, a digital video camera, and a digital gaming console.

In an embodiment according to the present invention, the electronic device may be adapted to securely communicate via one of a wire, a cable, an optical fiber, and wirelessly in two-way communication with the media exchange network.

In an embodiment according to the present invention, media may comprise one of audio, video, text, documents, and images.

In an embodiment according to the present invention, the electronic devices may comprise one of a same two and a different two of electronic device in a group comprising a personal computer (PC), a set-top-box, a television (TV) display-device comprising STB circuitry and software, and a media box (M-Box).

In an embodiment according to the present invention, media may be consumed by a media consumption-device adapted to display one of video, audio, text, images, documents, and digital information to a media receiving end-user.

In an embodiment according to the present invention, the electronic device may be adapted to securely communicate with a media exchange network comprising a broadband infrastructure, the broadband infrastructure comprising at least one of the Internet infrastructure, a copper cable infrastructure, a fiber optic cable infrastructure, a wireless telephone infrastructure, a wired telephone infrastructure, a direct subscriber line (DSL) infrastructure, an Over-The-Air (OTA) infrastructure, and an intranet infrastructure.

In an embodiment according to the present invention, the method may further comprise employing security techniques and associated security hardware.

In an embodiment according to the present invention, employing security techniques and associated security hardware may comprise employing one of a secure set-top-box, a secure digital TV product, a fingerprint reading device and associated method, a voice recognition device and associated method, an eye scanning device and associated method, an identification card reader and associated method, a bar code reader and associated method, a password-based authentication device and associated method, a digital certificate-based authentication device and associated method, a smart card-based authentication device and associated method, a GPS-based authentication device and associated method, and a receiver adapted to receive a signal transmitted from one of an implantable and a wearable micro-device and associated respective methods.

Aspects of the present invention may be found in an electronic device supporting secure exchange of multimedia information via a cable television (CATV) network. The electronic device may comprise at least one processor communicatively coupled to transmit/receive circuitry for sending and receiving multimedia information via the cable television (CATV) network. The at least one processor may also be coupled to decoder circuitry adapted for converting multimedia information for consumption by a first user. The electronic device may comprise memory capable of storing multimedia information, where the memory may be operably coupled to the at least one processor. The electronic device, at a first location, may be adapted to exchange multimedia information in a peer-to-peer fashion with a second electronic device of a second user, at a second location, via a broadband network comprising the cable television (CATV) network. In addition, the exchange of multimedia information between the electronic devices at the first location and second location may be enabled based upon verification of user-related security information.

In an embodiment of the present invention, the user-related security information may comprise a physical location of a mobile terminal associated with a user. The physical location may be determined based upon operation of the mobile terminal within a wireless network infrastructure, and the physical location may be determined using a satellite-based geo-location system. Verification may comprise comparing a predefined physical location to the physical location of a mobile terminal associated with a user. The user-related security information comprises one of the following: a password and a digital certificate.

In various embodiments of the present invention, the electronic device at the first location may comprise a set top box for interfacing a cable television network to a television, and the electronic device at the first location may comprise a personal computer. The second electronic device may comprise a set top box for interfacing a cable television network to a television, and the second electronic device may comprise a personal computer. The multimedia information may comprise one of the following: streaming video, broadcast video, digitized video, digitized audio, digitized still image(s), digitized music, text, and data. In an embodiment of the present invention, the broadband network may comprise the Internet. The cable television (CATV) network may distribute one of a plurality of cable programming channels, to the first location, based upon selection of the cable programming channel by a user at the first location.

Additional aspects of the present invention may be seen in a method of securely exchanging multimedia information via a broadband network comprising a cable television (CATV) network capable of distributing a plurality of channels of cable programming. In such a cable television (CATV) network, each channel may occupy a corresponding portion of cable television (CATV) network bandwidth. Such a method may comprise receiving, from a first location, a request for exchange of multimedia information with a second location, and receiving user-related information associated with authentication of the request. The method may also comprise verifying whether the first location is authorized to engage in the exchange of the multimedia information with the second location, using the user-related information. The method may enable exchange of multimedia information between the first location and the second location, if it is determined that the first location is authorized. The method may refrain from enabling exchange of multimedia information between the first location and the second location, if it is determined that the first location is not authorized. In an embodiment of the present invention, the exchange may be performed in a peer-to-peer fashion between the first location and the second location, via the cable television (CATV) network.

In one embodiment in accordance with the present invention, the user-related information may comprise a physical location of a mobile terminal associated with a user, where the physical location may be determined based upon operation of the mobile terminal within a wireless network infrastructure. In another embodiment of the present invention, the physical location may be determined using a satellite-based geo-location system. The verification may comprise comparing a predefined physical location to a physical location of the mobile terminal associated with a user. In various embodiments of the present invention, the user-related information may comprise one of the following: a password and a digital certificate.

In an embodiment of the present invention, the first location may comprise a set top box for interfacing the cable television (CATV) network to a television, and the first location may comprise a personal computer. The verification may be performed at the second location, and the verification may be performed at a third location that is remote from the first location and the second location. The multimedia information may comprise one of the following: streaming video, broadcast video, digitized video, digitized audio, digitized still image(s), digitized music, text, and data. The broadband network may comprise the Internet. In an embodiment of the present invention, the enabling may comprise allocating an unoccupied portion of cable television (CATV) network bandwidth for the exchange of the multimedia information.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. An electronic device supporting secure exchange of multimedia information via a cable television (CATV) network, the electronic device comprising:
at least one processor communicatively coupled to transmit/receive circuitry for sending and receiving multimedia information via the cable television (CATV) network, and to decoder circuitry adapted for converting multimedia information for consumption by a first user;
memory capable of storing multimedia information, the memory operably coupled to the at least one processor;
wherein the electronic device, at a first location, is adapted to exchange multimedia information in a peer-to-peer fashion with a second electronic device of a second user, at a second location, via a broadband network comprising the cable television (CATV) network; and
wherein the exchange of multimedia information between the electronic devices at the first location and second location is enabled based upon verification of user-related security information.

2. The electronic device according to claim 1 wherein the user-related security information comprises a physical location of a mobile terminal associated with a user.

3. The electronic device according to claim 2 wherein the physical location is determined based upon operation of the mobile terminal within a wireless network infrastructure.

4. The electronic device according to claim 2 wherein the physical location is determined using a satellite-based geo-location system.

5. The electronic device according to claim 2 wherein verification comprises comparing a predefined physical location to the physical location of a mobile terminal associated with a user.

6. The electronic device according to claim 1 wherein the user-related security information comprises one of the following: a password and a digital certificate.

7. The electronic device according to claim 1 wherein the electronic device at the first location comprises a set top box for interfacing a cable television network to a television.

8. The electronic device according to claim 1 wherein the electronic device at the first location comprises a personal computer.

9. The electronic device according to claim 1 wherein the second electronic device comprises a set top box for interfacing a cable television network to a television.

10. The electronic device according to claim 1 wherein the second electronic device comprises a personal computer.

11. The electronic device according to claim 1 wherein the multimedia information comprises one of the following: streaming video, broadcast video, digitized video, digitized audio, digitized still image(s), digitized music, text, and data.

12. The electronic device according to claim 1, wherein the broadband network comprises the Internet.

13. The electronic device according to claim 1, wherein the cable television (CATV) network distributes one of a plurality of cable programming channels, to the first location, based upon selection of the cable programming channel by a user at the first location.

14. A method of securely exchanging multimedia information via a broadband network comprising a cable television (CATV) network capable of distributing a plurality of channels of cable programming, each channel occupying a corresponding portion of cable television (CATV) network bandwidth, the method comprising:
receiving, from a first location, a request for exchange of multimedia information with a second location;
receiving user-related information associated with authentication of the request;
verifying whether the first location is authorized to engage in the exchange of the multimedia information with the second location, using the user-related information;
enabling exchange of multimedia information between the first location and the second location, if it is determined that the first location is authorized;
refraining from enabling exchange of multimedia information between the first location and the second location, if it is determined that the first location is not authorized; and
wherein the exchange is performed in a peer-to-peer fashion between the first location and the second location, via the cable television (CATV) network.

15. The method according to claim 14, wherein the user-related information comprises a physical location of a mobile terminal associated with a user.

16. The method according to claim 15 wherein the physical location is determined based upon operation of the mobile terminal within a wireless network infrastructure.

17. The method according to claim 15 wherein the physical location is determined using a satellite-based geo-location system.

18. The method according to claim 15 wherein verification comprises comparing a predefined physical location to a physical location of the mobile terminal associated with a user.

19. The method according to claim 14 wherein the user-related information comprises one of the following: a password and a digital certificate.

20. The method according to claim 14, wherein the first location comprises a set top box for interfacing the cable television (CATV) network to a television.

21. The method according to claim 14 wherein the first location comprises a personal computer.

22. The method according to claim 14 wherein the verification is performed at the second location.

23. The method according to claim 14 wherein the verification is performed at a third location that is remote from the first location and the second location.

24. The method according to claim 14, wherein the multimedia information comprises one of the following: streaming video, broadcast video, digitized video, digitized audio, digitized still image(s), digitized music, text, and data.

25. The method according to claim 14, wherein the broadband network comprises the Internet.

26. The method according to claim 14, wherein the enabling comprises:
allocating an unoccupied portion of cable television (CATV) network bandwidth for the exchange of the multimedia information.
